(19) United States
(12) Patent Application Publication
(10) Pub. No.: US 2017/0114272 A1
(43) Pub. Date: Apr. 27, 2017

(54) Scale Inhibitor and Methods of Using Scale Inhibitors

(71) Applicant: HALLIBURTON ENERGY SERVICES, INC., Houston, TX (US)

(72) Inventors: Loan K. Vo, Houston, TX (US); James William Ogle, Spring, TX (US); Bradley J. Sparks, Richmond, TX (US)

(73) Assignee: Halliburton Energy Services, Inc., Houston, TX (US)

(21) Appl. No.: 15/318,963

(22) PCT Filed: Jul. 9, 2014
(86) PCT No.: PCT/US2014/045908

§ 371 Date: Dec. 14, 2016

(51) Int. Cl. C09K 8/70; E21B 43/26; C09K 8/88; E21B 37/06; B01J 13/02; C09K 8/68

(52) U.S. Cl. CPC C09K 8/706; B01J 13/02; C09K 8/685; C09K 8/887; E21B 37/06; E21B 43/26; C09K 2208/26; C09K 2208/24

(57) ABSTRACT

Various embodiments disclosed relate to scale inhibitors and methods of treating a subterranean formation with the same. In various embodiments, the present invention provides a method of treating a subterranean formation including obtaining or providing a composition including a scale inhibitor, wherein at least one of A and B is satisfied. In A, the scale inhibitor can include at least one of 1) a copolymer including a repeating unit including at least one sulfonic acid or sulfonate group and a repeating unit including at least two carboxylic acid or carboxylate groups, and 2) a protected scale inhibitor including hydrolyzably-unmaskable coordinating groups. In B, the composition includes an aqueous phase and a lipophilic phase, wherein the lipophilic phase protectively encapsulates the scale inhibitor. The method includes placing the composition in a subterranean formation.

### BACKGROUND OF THE INVENTION

Scale deposition is a common cause of reduced production, especially in mature hydrocarbon wells. Scale inhibitors can be applied during hydraulic fracturing operations to help avoid scale build up during the production phase. Although various compounds can coordinate to scale-forming ions and prevent them from forming scale, these compounds also tend to coordinate to other materials to cause undesirable effects. For example, various coordinating compounds, while effective for scale reduction, can reduce the crosslinking performance of transition metal-crosslinked viscosification systems.

### BRIEF DESCRIPTION OF THE FIGURES

The drawings illustrate generally, by way of example, but not by way of limitation, various embodiments discussed in the present document.

FIG. 1 illustrates a drilling assembly, in accordance with various embodiments.

FIG. 2 illustrates a system or apparatus for delivering a composition to a subterranean formation, in accordance with various embodiments.

FIG. 3 illustrates viscosity testing with heating of samples of a zirconium-crosslinked hydroxypropyl guar fracturing fluid having various concentrations of sodium allylsulfonate/maleic acid copolymer scale inhibitor and various concentrations of breaker, in accordance with various embodiments.

FIG. 4 illustrates the viscosity of the Al/Zr-crosslinked crosslinked carboxymethyl hydroxyethylcellulose (CMHEC) fracturing fluid sample without the scale inhibitor.

FIG. 5 illustrates the viscosity of the Al/Zr-crosslinked crosslinked carboxymethyl hydroxyethylcellulose (CMHEC) fracturing fluid sample with the scale inhibitor.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods of manufacturing described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

Selected substituents within the compounds described herein are present to a recursive degree. In this context, “recursive substituent” means that a substituent may recite another instance of itself or of another substituent that itself recites the first substituent. Recursive substituents are an intended aspect of the disclosed subject matter. Because of the recursive nature of such substituents, theoretically, a large number may be present in any given claim. One of ordinary skill in the art of organic chemistry understands that the total number of such substituents is reasonably limited by the desired properties of the compound intended. Such properties include, by way of example and not limitation, physical properties such as molecular weight, solubility, and practical properties such as ease of synthesis. Recursive substituents can call back on themselves any suitable number of times, such as about 1 time, about 2 times, 3, 4, 5, 6, 7, 8, 9, 10, 15, 20, 30, 50, 100, 200, 300, 400, 500, 750, 1000, 1500, 2000, 3000, 4000, 5000, 10,000, 15,000, 20,000, 30,000, 50,000, 100,000, 200,000, 500,000, 750,000, or about 1,000,000 times or more.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “organic group” as used herein refers to but is not limited to any carbon-containing functional group. For example, an oxygen-containing group such as an alkoxy group, aryloxy group, aralkyloxy group, oxo(carbonyl) group, a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R, wherein R can be hydrogen (in examples that include other carbon atoms) or a carbon-based moiety, and wherein the carbon-based moiety can itself be further substituted.

The term “substituted” as used herein refers to an organic group as defined herein or molecule in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents J that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R, wherein R can be hydrogen or a carbon-based moiety, and wherein the carbon-based moiety can itself be further substituted; for example, wherein R can be hydrogen, alkyl, acyl, cycloalkyl, aryl, aralkyl, heterocyclyl, heteroaryl, or heteroarylalkyl, wherein any alkyl, acyl, cycloalkyl, aryl, aralkyl, heterocyclyl, heteroaryl, or heteroarylalkyl or R can be independently mono- or multi-substituted with J; or wherein two R groups bonded to a nitrogen atom or to adjacent nitrogen atoms can together with the nitrogen atom or atoms form a heterocyclyl, which can be mono- or independently multi-substituted with J.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃) among others.

The term “aryl” as used herein refers to cyclic aromatic hydrocarbons that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those listed herein.

The term “aralkyl” as used herein refers to alkyl groups as defined herein in which a hydrogen or carbon bond of an alkyl group is replaced with a bond to an aryl group as defined herein. Representative aralkyl groups include benzyl and phenylethyl groups and fused (cycloalkylaryl)alkyl groups such as 4-ethyl-indanyl. Aralkenyl groups are alkenyl groups as defined herein in which a hydrogen or carbon bond of an alkyl group is replaced with a bond to an aryl group as defined herein.

The term “heterocyclyl” as used herein refers to aromatic and non-aromatic ring compounds containing 3 or more ring members, of which one or more is a heteroatom such as, but not limited to, N, O, and S. Thus, a heterocyclyl can be a cycloheteroalkyl, or a heteroaryl, or if polycyclic, any combination thereof. In some embodiments, heterocyclyl groups include 3 to about 20 ring members, whereas other such groups have 3 to about 15 ring members. A heterocyclyl group designated as a C₂-heterocyclyl can be a 5-ring with two carbon atoms and three heteroatoms, a 6-ring with two carbon atoms and four heteroatoms and so forth. Likewise a C₄-heterocyclyl can be a 5-ring with one heteroatom, a 6-ring with two heteroatoms, and so forth. The number of carbon atoms plus the number of heteroatoms equals the total number of ring atoms. A heterocyclyl ring can also include one or more double bonds. A heteroaryl ring is an embodiment of a heterocyclyl group. The phrase “heterocyclyl group” includes fused ring species including those that include fused aromatic and non-aromatic groups.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” as used herein refers to a functional group or molecule that includes carbon and hydrogen atoms. The term can also refer to a functional group or molecule that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof.

The term “solvent” as used herein refers to a liquid that can dissolve a solid, liquid, or gas. Nonlimiting examples of solvents are silicones, organic compounds, water, alcohols, ionic liquids, and supercritical fluids.

The term “number-average molecular weight” as used herein refers to the ordinary arithmetic mean of the molecular weight of individual molecules in a sample. It is defined as the total weight of all molecules in a sample divided by the total number of molecules in the sample. Experimentally, the number-average molecular weight (Mₙ) is determined by analyzing a sample divided into molecular weight fractions of species i having nᵢ molecules of molecular weight Mᵢ through the formula Mₙ=ΣMᵢnᵢ/Σnᵢ. The number-average molecular weight can be measured by a variety of well-known methods including gel permeation chromatography, spectroscopic end group analysis, and osmometry. If unspecified, molecular weights of polymers given herein are number-average molecular weights.

The term “weight-average molecular weight” as used herein refers to M_{w}, which is equal to ΣMᵢ²nᵢ/ΣMᵢnᵢ, where nᵢ is the number of molecules of molecular weight Mᵢ. In various examples, the weight-average molecular weight can be determined using light scattering, small angle neutron scattering, X-ray scattering, and sedimentation velocity.

The term “room temperature” as used herein refers to a temperature of about 15° C. to 28° C.

The term “standard temperature and pressure” as used herein refers to 20° C. and 101 kPa.

As used herein, “degree of polymerization” is the number of repeating units in a polymer.

As used herein, the term “polymer” refers to a molecule having at least one repeating unit and can include copolymers.

The term “copolymer” as used herein refers to a polymer that includes at least two different repeating units. A copolymer can include any suitable number of repeating units.

The term “downhole” as used herein refers to under the surface of the earth, such as a location within or fluidly connected to a wellbore.

As used herein, the term “drilling fluid” refers to fluids, slurries, or muds used in drilling operations downhole, such as during the formation of the wellbore.

As used herein, the term “stimulation fluid” refers to fluids or slurries used downhole during stimulation activities of the well that can increase the production of a well, including perforation activities. In some examples, a stimulation fluid can include a fracturing fluid or an acidizing fluid.

As used herein, the term “clean-up fluid” refers to fluids or slurries used downhole during clean-up activities of the well, such as any treatment to remove material obstructing the flow of desired material from the subterranean formation. In one example, a clean-up fluid can be an acidification treatment to remove material formed by one or more perforation treatments. In another example, a clean-up fluid can be used to remove a filter cake.

As used herein, the term “fracturing fluid” refers to fluids or slurries used downhole during fracturing operations.

As used herein, the term “spotting fluid” refers to fluids or slurries used downhole during spotting operations, and can be any fluid designed for localized treatment of a downhole region. In one example, a spotting fluid can include a lost circulation material for treatment of a specific section of the wellbore, such as to seal off fractures in the wellbore and prevent sag. In another example, a spotting fluid can include a water control material. In some examples, a spotting fluid can be designed to free a stuck piece of drilling or extraction equipment, can reduce torque and drag with drilling lubricants, prevent differential sticking, promote wellbore stability, and can help to control mud weight.

As used herein, the term “completion fluid” refers to fluids or slurries used downhole during the completion phase of a well, including cementing compositions.

As used herein, the term “remedial treatment fluid” refers to fluids or slurries used downhole for remedial treatment of a well. Remedial treatments can include treatments designed to increase or maintain the production rate of a well, such as stimulation or clean-up treatments.

As used herein, the term “abandonment fluid” refers to fluids or slurries used downhole during or preceding the abandonment phase of a well.

As used herein, the term “acidizing fluid” refers to fluids or slurries used downhole during acidizing treatments. In one example, an acidizing fluid is used in a clean-up operation to remove material obstructing the flow of desired material, such as material formed during a perforation operation. In some examples, an acidizing fluid can be used for damage removal.

As used herein, the term “cementing fluid” refers to fluids or slurries used during cementing operations of a well. For example, a cementing fluid can include an aqueous mixture including at least one of cement and cement kiln dust. In another example, a cementing fluid can include a curable resinous material such as a polymer that is in an at least partially uncured state.

As used herein, the term “water control material” refers to a solid or liquid material that interacts with aqueous material downhole, such that hydrophobic material can more easily travel to the surface and such that hydrophilic material (including water) can less easily travel to the surface. A water control material can be used to treat a well to cause the proportion of water produced to decrease and to cause the proportion of hydrocarbons produced to increase, such as by selectively binding together material between water-producing subterranean formations and the wellbore while still allowing hydrocarbon-producing formations to maintain output.

As used herein, the term “packing fluid” refers to fluids or slurries that can be placed in the annular region of a well between tubing and outer casing above a packer. In various examples, the packing fluid can provide hydrostatic pressure in order to lower differential pressure across the sealing element, lower differential pressure on the wellbore and casing to prevent collapse, and protect metals and elastomers from corrosion.

As used herein, the term “fluid” refers to liquids and gels, unless otherwise indicated.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidizing, completion, cementing, remedial treatment, abandonment, and the like.

As used herein, a “flow pathway” downhole can include any suitable subterranean flow pathway through which two subterranean locations are in fluid connection. The flow pathway can be sufficient for petroleum or water to flow from one subterranean location to the wellbore or vice-versa. A flow pathway can include at least one of a hydraulic fracture, and a fluid connection across a screen, across gravel pack, across proppant, including across resin-bonded proppant or proppant deposited in a fracture, and across sand. A flow pathway can include a natural subterranean passageway through which fluids can flow. In some embodiments, a flow pathway can be a water source and can include water. In some embodiments, a flow pathway can be a petroleum source and can include petroleum. In some embodiments, a flow pathway can be sufficient to divert from a wellbore, fracture, or flow pathway connected thereto at least one of water, a downhole fluid, or a produced hydrocarbon.

As used herein, a “carrier fluid” refers to any suitable fluid for suspending, dissolving, mixing, or emulsifying with one or more materials to form a composition. For example, the carrier fluid can be at least one of crude oil, dipropylene glycol methyl ether, dipropylene glycol dimethyl ether, dipropylene glycol methyl ether, dipropylene glycol dimethyl ether, dimethyl formamide, diethylene glycol methyl ether, ethylene glycol butyl ether, diethylene glycol butyl ether, butylglycidyl ether, propylene carbonate, D-limonene, a C₂-C₄₀ fatty acid C₁-C₁₀ alkyl ester (e.g., a fatty acid methyl ester), tetrahydrofurfuryl methacrylate, tetrahydrofurfuryl acrylate, 2-butoxy ethanol, butyl acetate, butyl lactate, furfuryl acetate, dimethyl sulfoxide, dimethyl formamide, a petroleum distillation product of fraction (e.g., diesel, kerosene, napthas, and the like) mineral oil, a hydrocarbon oil, a hydrocarbon including an aromatic carbon-carbon bond (e.g., benzene, toluene), a hydrocarbon including an alpha olefin, xylenes, an ionic liquid, methyl ethyl ketone, an ester of oxalic, maleic or succinic acid, methanol, ethanol, propanol (iso- or normal-), butyl alcohol (iso-, tert-, or normal-), an aliphatic hydrocarbon (e.g., cyclohexanone, hexane), water, brine, produced water, flowback water, brackish water, and sea water. The fluid can form about 0.001 wt % to about 99.999 wt % of a composition or a mixture including the same, or about 0.001 wt % or less, 0.01 wt %, 0.1, 1, 2, 3, 4, 5, 6, 8, 10, 15, 20, 25, 30, 35, 40, 45, 50, 55, 60, 65, 70, 75, 80, 85, 90, 95, 96, 97, 98, 99, 99.9, 99.99, or about 99.999 wt % or more.

In various embodiments, the present invention provides a method of treating a subterranean formation. The method includes obtaining or providing a composition including a scale inhibitor, wherein at least one of A and B is satisfied. In A, the scale inhibitor includes at least one of 1) a copolymer including a repeating unit including at least one sulfonic acid or sulfonate group and a repeating unit including at least two carboxylic acid or carboxylate groups, and 2) a protected scale inhibitor including hydrolyzably-unmaskable coordinating groups. In B, the composition includes an aqueous phase and a lipophilic phase, wherein the lipophilic phase protectively encapsulates the scale inhibitor. The method also includes placing the composition in a subterranean formation.

In various embodiments, the present invention provides a method of treating a subterranean formation. The method includes obtaining or providing a composition including a scale inhibitor that is a copolymer including repeating units having the structure:

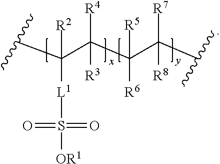

The repeating units are in block or random copolymer arrangement and, at each occurrence, independently occur in the direction shown or in the opposite direction. At each occurrence, each of R², R³, R⁴, R⁵, R⁶, R⁷, and R⁸ is independently selected from the group consisting of —H and substituted or unsubstituted (C₁-C₂₀)hydrocarbyl. At each occurrence, L¹ is independently selected from the group consisting of a bond and a substituted or unsubstituted (C₁-C₂₀)hydrocarbylene interrupted or terminated by 0, 1, 2, or 3 groups chosen from —O—, —NH—, and —S—. At least two of R⁵, R⁶, R⁷, and R⁸ include a carboxylic acid, a salt thereof, or an ester thereof. At each occurrence, R¹ is independently selected from the group consisting of —H, a counterion, and a substituted or unsubstituted (C₁-C₂₀)hydrocarbyl. The method also includes placing the composition in a subterranean formation.

In various embodiments, the present invention provides a system. The system includes a composition that includes a scale inhibitor, wherein at least one of A and B is satisfied. In A, the scale inhibitor includes at least one of 1) a copolymer including a repeating unit including at least one sulfonic acid or sulfonate group and a repeating unit including at least two carboxylic acid or carboxylate groups and 2) a protected scale inhibitor including hydrolyzably-unmaskable coordinating groups. In B, the composition includes an aqueous phase and a lipophilic phase, wherein the lipophilic phase protectively encapsulates the scale inhibitor. The system also includes a subterranean formation including the composition therein.

In various embodiments, the present invention provides a composition for treatment of a subterranean formation. The composition includes a scale inhibitor, wherein at least one of A and B is satisfied. In A, the scale inhibitor includes at least one of 1) a copolymer including a repeating unit including at least one sulfonic acid or sulfonate group and a repeating unit including at least two carboxylic acid or carboxylate groups, and 2) a protected scale inhibitor including hydrolyzably-unmaskable coordinating groups. In B, the composition includes an aqueous phase and a lipophilic phase, wherein the lipophilic phase protectively encapsulates the scale inhibitor.

In various embodiments, the present invention provides a composition for treatment of a subterranean formation. The composition includes a scale inhibitor that is a copolymer including repeating units having the structure:

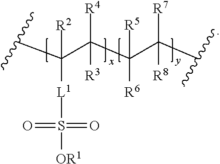

The repeating units are in block or random copolymer arrangement and, at each occurrence, independently occur in the direction shown or in the opposite direction. At each occurrence, each of R², R³, R⁴, R⁵, R⁶, R⁷, and R⁸ is independently selected from the group consisting of —H and substituted or unsubstituted (C₁-C₂₀)hydrocarbyl. At each occurrence, L¹ is independently selected from the group consisting of a bond and a substituted or unsubstituted (C₁-C₂₀)hydrocarbylene interrupted or terminated by 0, 1, 2, or 3 groups chosen from —O—, —NH—, and —S—. At least two of R⁵, R⁶, R⁷, and R⁸ include a carboxylic acid, a salt thereof, or an ester thereof. At each occurrence, R¹ is independently selected from the group consisting of —H, a counterion, and a substituted or unsubstituted (C₁-C₂₀)hydrocarbyl. In some embodiments, the scale inhibitor includes repeating units having the structure:

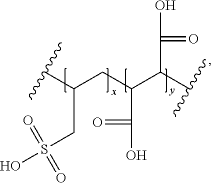

wherein the repeating units are in block or random copolymer arrangement and, at each occurrence, independently occur in the direction shown or in the opposite direction.

In various embodiments, the present invention provides a method of preparing a composition for treatment of a subterranean formation. The method includes forming a composition including a scale inhibitor, wherein at least one of A and B is satisfied. In A, the scale inhibitor includes at least one of 1) a copolymer including a repeating unit including at least one sulfonic acid or sulfonate group and a repeating unit including at least two carboxylic acid or carboxylate groups, and 2) a protected scale inhibitor including hydrolyzably-unmaskable coordinating groups. In B, the composition includes an aqueous phase and a lipophilic phase, wherein the lipophilic phase protectively encapsulates the scale inhibitor.

Various embodiments of the present invention provide certain advantages, at least some of which are unexpected. In various embodiments, the scale inhibitor or method of using a scale inhibitor can have fewer undesired interactions with non-scale forming materials than other scale inhibitors or methods of using scale inhibitors. In various embodiments, the present invention provides a scale inhibitor or a method of using a scale inhibitor that has greater compatibility with transition-metal crosslinked viscosification systems than other scale inhibitors or methods of using scale inhibitors. In various embodiments, the present invention provides a scale inhibitor or method of using a scale inhibitor that can be used in the presence of transition-metal crosslinked systems with substantially no decrease in viscosity as compared to a corresponding system not including the scale inhibitor or using a scale inhibitor without using the method. In various embodiments, the present invention provides a scale inhibitor or method of using a scale inhibitor that can be used in the presence of transition-metal crosslinked systems with less decrease in viscosity as compared to a corresponding system not including the scale inhibitor but including a different scale inhibitor, or as compared to a corresponding system used with a different method of using the scale inhibitor.

In various embodiments, the scale inhibitor is a liquid scale inhibitor that does not suffer from some of the disadvantages of solid scale inhibitors such as at least one of incompatibility with resin or tackifying systems, difficulty maintaining homogeneity, left-behind coatings having a negative impact in proppant conductivity, and difficulty penetrating a formation. In various embodiments, the liquid form of the scale inhibitor can provide more effective inhibition of scale deposition and with a greater rate of production over a longer period of time as compared to other scale inhibitors.

### Method of Treating a Subterranean Formation.

In some embodiments, the present invention provides a method of treating a subterranean formation. The method includes obtaining or providing a composition including a scale inhibitor. The obtaining or providing of the composition can occur at any suitable time and at any suitable location. The obtaining or providing of the composition can occur above the surface. The obtaining or providing of the composition can occur in the subterranean formation (e.g., downhole). The method also includes placing the composition in a subterranean formation. The placing of the composition in the subterranean formation can include contacting the composition and any suitable part of the subterranean formation, or contacting the composition and a subterranean material, such as any suitable subterranean material. The subterranean formation can be any suitable subterranean formation. In some examples, the placing of the composition in the subterranean formation includes contacting the composition with or placing the composition in at least one of a fracture, at least a part of an area surrounding a fracture, a flow pathway, an area surrounding a flow pathway, and an area desired to be fractured. The placing of the composition in the subterranean formation can be any suitable placing and can include any suitable contacting between the subterranean formation and the composition.

The method can include hydraulic fracturing, such as a method of hydraulic fracturing to generate a fracture or flow pathway. The placing of the composition in the subterranean formation or the contacting of the subterranean formation and the hydraulic fracturing can occur at any time with respect to one another; for example, the hydraulic fracturing can occur at least one of before, during, and after the contacting or placing. In some embodiments, the contacting or placing occurs during the hydraulic fracturing, such as during any suitable stage of the hydraulic fracturing, such as during at least one of a pre-pad stage (e.g., during injection of water with no proppant, and additionally optionally mid- to low-strength acid), a pad stage (e.g., during injection of fluid only with no proppant, with some viscosifier, such as to begin to break into an area and initiate fractures to produce sufficient penetration and width to allow proppant-laden later stages to enter), or a slurry stage of the fracturing (e.g., viscous fluid with proppant). In some embodiments, the composition including the scale inhibitor can be applied into linear gel fracturing fluid as part of the first pad fluid. The method can include performing a stimulation treatment at least one of before, during, and after placing the composition in the subterranean formation in the fracture, flow pathway, or area surrounding the same. The stimulation treatment can be, for example, at least one of perforating, acidizing, injecting of cleaning fluids, propellant stimulation, and hydraulic fracturing. In some embodiments, the stimulation treatment at least partially generates a fracture or flow pathway where the composition is placed or contacted, or the composition is placed or contacted to an area surrounding the generated fracture or flow pathway. In some embodiments, the scale inhibitor can be applied into the subterranean formation in the absence of any fracturing fluid.

In some embodiments, the method can be a method of drilling, stimulation, fracturing, spotting, clean-up, completion, remedial treatment, applying a pill, acidizing, cementing, or a combination thereof.

The composition can include one scale inhibitor or multiple scale inhibitors. The composition can include any suitable amount of the one scale inhibitor or the multiple scale inhibitors, such that the composition can be used as described herein. In some embodiments about 0.001 wt % to about 100 wt % of the composition can be the scale inhibitor of the multiple scale inhibitors, or about 0.01 wt % to about 5 wt %, or about 0.001 wt % or less, or about 0.01 wt %, 0.1, 1, 2, 3, 4, 5, 10, 15, 20, 25, 30, 35, 40, 45, 50, 55, 60, 65, 70, 75, 80, 85, 90, 95, 96, 97, 98, 99, 99.5, 99.9, 99.99, or about 99.999 wt % or more. The remainder of the composition can be any suitable one or more components, such as downhole fluid, additives, proppant, carrier fluids, and the like, as described herein. In some embodiments, the composition is a concentrated solution designed to be mixed with other components for dilution prior to scale inhibition in the subterranean formation. In some embodiments, the composition includes the scale inhibitor at a concentration appropriate for scale inhibition in the subterranean formation.

Scale Inhibitor.

The composition includes a scale inhibitor. The scale inhibitor can be at least one of 1) a copolymer including a repeating unit including at least one sulfonic acid or sulfonate group and a repeating unit including at least two carboxylic acid or carboxylate groups, and 2) a protected scale inhibitor including hydrolyzably-unmaskable coordinating groups. The scale inhibitor and the concentration at which the scale inhibitor is present in the composition can be such that the composition has about no decreased viscosity as compared to a corresponding composition not including the scale inhibitor. The scale inhibitor and the concentration at which the scale inhibitor is present in the composition can be sufficient such that the composition has about 50% to about 100% of the viscosity of a corresponding composition not including the scale inhibitor, or about 60% to about 99%, about 70% to about 95%, or about 50% or less, or about 55%, 60, 65, 70, 75, 80, 85, 90, 91, 92, 93, 94, 95, 96, 97, 98, 99, 99.5, 99.9, 99.99, or about 99.999% or more.

The copolymer including a repeating unit including at least one sulfonic acid or sulfonate group and a repeating unit including at least two carboxylic acid or carboxylate groups can include repeating units having the structure:

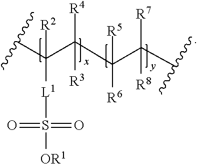

The repeating units are in block or random copolymer arrangement and, at each occurrence, can independently occur in the direction shown or in the opposite direction. In various embodiments, this copolymer can be particularly selective for barium, strontium, and iron ions, preventing them from forming scale in formations with high sulfate concentrations, while allowing metal crosslinkers such as Al, Zr, and Ti to perform crosslinking.

At each occurrence, each of R², R³, R⁴, R⁵, R⁶, R⁷, R⁸ can be independently selected from the group consisting of —H and substituted or unsubstituted (C₁-C₂₀)hydrocarbyl, wherein at least two of R⁵, R⁶, R⁷, and R⁸ include a carboxylic acid, a salt thereof, or an ester thereof (e.g., a (C₁-C₂₀)hydrocarbyl ester thereof). Each of R², R³, R⁴, R⁵, R⁶, R⁷, R⁸ can be independently selected from the group consisting of —H and (C₁-C₁₀)alkyl, wherein at least two of R⁵, R⁶, R⁷, and R⁸ can be substituted with at least one carboxylic acid or carboxylate. Each of R², R³, R⁴, R⁵, R⁸ can be —H, and, at each occurrence, R⁶ and R⁷ can be each independently selected from a carboxylic acid and (C₁-C₁₀)alkyl substituted by at least one carboxylic acid and interrupted or terminated by 0, 1, 2, or 3 groups chosen from —O—, —NH—, and —S—.

At each occurrence, L¹ can be independently selected from the group consisting of a bond and a substituted or unsubstituted (C₁-C₂₀)hydrocarbylene interrupted or terminated by 0, 1, 2, or 3 groups chosen from —O—, —NH—, and —S—. At each occurrence, L¹ can be independently selected from the group consisting of a bond and a (C₁-C₁₀)alkylene interrupted or terminated by 0, 1, 2, or 3 groups chosen from —O—, —NH—, and —S—. At each occurrence, L¹ can be independently selected from the group consisting of a bond and a (C₁-C₅)alkylene. The variable L¹ can be methylene.

At each occurrence, R¹ can be independently selected from the group consisting of —H, a counterion, and a substituted or unsubstituted (C₁-C₂₀)hydrocarbyl (e.g., (C₁-C₅)alkyl). The counterion can be any suitable counterion. At each occurrence, the variable R¹ can be selected from the group consisting of —H, (C₁-C₅)alkyl, Na⁺, K⁺, Li⁺, H⁺, Zn⁺, NH₄⁺, Ca²⁺, Mg²⁺, Zn²⁺, and Al³⁺. The variable R¹ can be −H.

The copolymer including a repeating unit including at least one sulfonic acid or sulfonate group and a repeating unit including at least two carboxylic acid or carboxylate groups can include repeating units having the structure:

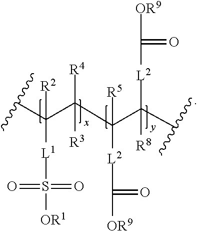

The repeating units are in block or random copolymer arrangement and, at each occurrence, independently occur in the direction shown or in the opposite direction,

At each occurrence, L² can be independently selected from the group consisting of a bond and a substituted or unsubstituted (C₁-C₂₀)hydrocarbylene interrupted or terminated by 0, 1, 2, or 3 groups chosen from —O—, —NH—, and —S—. At each occurrence, L² can be independently selected from the group consisting of a bond and a (C₁-C₁₀)alkylene interrupted or terminated by 0, 1, 2, or 3 groups chosen from —O—, —NH—, and —S—. At each occurrence, L² can be independently selected from the group consisting of a bond and a (C₁-C₅)alkylene. The variable L² can be a bond.

At each occurrence, R⁹ can be independently selected from the group consisting of —H, a counterion, and a substituted or unsubstituted (C₁-C₂₀)hydrocarbyl. The variable R⁹ can be selected from the group consisting of —H, (C₁-C₅)alkyl, Na⁺, K⁺, Li⁺, H⁺, Zn⁺, NH₄⁺, Ca²⁺, Mg²⁺, Zn²⁺, and Al³⁺. The variable R⁹ is —H.

The variable x can be any suitable integer value, such as about 1 to about 200, or about 4 to about 30, or about 1, 2, 3, 4, 5, 6, 8, 10, 12, 14, 16, 18, 20, 22, 24, 26, 28, 30, 35, 40, 45, 50, 60, 70, 80, 90, 100, 110, 120, 130, 140, 150, 160, 170, 180, 190, or about 200 or more. The variable y can be any suitable integer value, such as about 1 to about 200, or about 4 to about 30, or about 1, 2, 3, 4, 5, 6, 8, 10, 12, 14, 16, 18, 20, 22, 24, 26, 28, 30, 35, 40, 45, 50, 60, 70, 80, 90, 100, 110, 120, 130, 140, 150, 160, 170, 180, 190, or about 200 or more. The value of the percent of the repeating unit having degree of polymerization x with respect to the total amount of repeating units having degrees of polymerization x and y (e.g., x/(x+y)) can be any suitable percent, such as about 0.1% to about 99.9%, about 20% to about 80%, about 50% to about 90%, or about 0.1% or less, or about 0.5%, 1, 2, 3, 4, 5, 6, 8, 10, 12, 14, 16, 18, 20, 25, 30, 35, 40, 45, 50, 55, 60, 65, 70, 75, 80, 85, 90, 95, 96, 97, 98, 99, or about 99.9% or more. The value of the percent of the repeating unit having degree of polymerization y with respect to the total amount of repeating units having degrees of polymerization x and y (e.g., y/(x+y)) can be any suitable percent, such as about 0.1% to about 99.9%, about 20% to about 80%, about 10% to about 50%, about 0.1% or less, or about 0.5%, 1, 2, 3, 4, 5, 6, 8, 10, 12, 14, 16, 18, 20, 25, 30, 35, 40, 45, 50, 55, 60, 65, 70, 75, 80, 85, 90, 95, 96, 97, 98, 99, or about 99.9% or more. In some embodiments, the repeating unit having degree of polymerization x and the repeating unit having degree of polymerization y are only two repeating units in the copolymer. The copolymer can have any suitable molecular weight, such as about 500 g/mol to about 20,000 g/mol, about 2,500 g/mol to about 3,500 g/mol, about 500 g/mol or less, or about 750, 1,000, 1,250, 1,500, 1,750, 2,000, 2,250, 2,500, 2,750, 3,000, 3,250, 3,500, 4,000, 5,000, 7,500, 10,000, 12,500, 15,000, 17,500, or about 20,000 g/mol or more.

In various embodiments, the scale inhibitor includes repeating units having the structure:

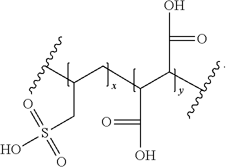

The repeating units are in block or random copolymer arrangement and, at each occurrence, independently occur in the direction shown or in the opposite direction. The sulfonate-containing repeating unit can be formed from sodium allyl sulfonate or any other suitable salt of allyl sulfonate.

The protected scale inhibitor including hydrolyzably-unmaskable coordinating groups can be any suitable scale inhibitor having groups that can coordinate to and at least partially bind with scale-forming ions following hydrolysis of a masking group on the coordinating group. By masking the coordinating group, crosslinker metals and other materials have an opportunity to perform their duties (e.g., crosslinking) prior to the hydrolysis and unmasking of the coordinating groups, thereby preventing or reducing the frequency with which the coordinating groups interfere with non-scale forming materials and mechanisms dependent thereon. The hydrolyzably-unmaskable coordinating groups can be any suitable groups, such as including at least one of an ester (e.g., a (C₁-C₂₀) hydrocarbyl ester), an anhydride (e.g., a condensate of the same molecule or with any substituted or unsubstituted (C₁-C₅₀)hydrocarbylcarboxylic acid, and an amide (e.g., substituted or unsubstititued). In some embodiments, the method includes hydrolyzing at least some of the hydrolyzably-unmaskable coordinating groups while the composition is in the subterranean formation, such as via any hydrolysis technique, such as via acid- or base-catalyzed hydrolysis. In some embodiments, the conditions downhole, such as at least one of temperature, pressure, and pH, can trigger the hydrolysis.

In some embodiments, the protected scale inhibitor including hydrolyzably-unmaskable coordinating groups can be a polymer, wherein at least one repeating unit of the polymer includes the hydrolyzably-unmaskable coordinating group. The polymeric protected scale inhibitor including hydrolyzably-unmaskable coordinating groups can include a repeating unit that is derived from a (C₁-C₂₀)hydrocarbyl ester, anhydride, or substituted or unsubstituted amide of at least one of a substituted or unsubstituted (C₃-C₂₀)alkenoic acid and a substituted or unsubstituted (C₁-C₂₀)hydrocarbylsulfonic acid. The polymeric protected scale inhibitor including hydrolyzably-unmaskable coordinating groups can include a (C₁-C₂₀)hydrocarbyl ester, anhydride, or substituted or unsubstituted amide of at least one of a carboxylic acid- or sulfonic acid-substituted (C₂-C₂₀)hydrocarbylene, wherein the (C₂-C₂₀)hydrocarbylene is substituted or unsubstituted, an acrylamido-methyl propane sulfonate/acrylic acid copolymer (AMPS/AA), phosphinated maleic copolymer (PHOS/MA), a polymaleic acid/acrylic acid/acrylamido-methyl propane sulfonate terpolymer (PMA/AMPS), a phosphonate polymer, a polycarboxylate, a phosphorous-containing polycarboxylate, a phosphonic acid derivative, a phosphino-polylacrylate, and a copolymer including any one of the preceding polymers or copolymers. The polymeric protected scale inhibitor including hydrolyzably-unmaskable coordinating groups can be a polyphosphonic acid (C₁-C₂₀)hydrocarbyl ester, anhydride, or substituted or unsubstituted amide.

The repeating unit including the hydrolyzably-unmaskable coordinating group can be hydrolyzable to form a repeating unit that is a carboxylic acid- or sulfonic acid-substituted (C₂-C₂₀)hydrocarbylene, wherein the (C₂-C₂₀)hydrocarbylene is substituted or unsubstituted. The polymeric protected scale inhibitor including hydrolyzably-unmaskable coordinating groups can include at least one repeating unit that is derived from an acrylic acid or methacrylic acid isobutyl ester. The polymeric protected scale inhibitor including hydrolyzably-unmaskable coordinating groups can include at least one repeating unit that is derived from an acrylic acid or methacrylic acid (C₁-C₅)ester, anhydride, or amide. The repeating unit including the hydrolyzably-unmaskable coordinating group can be hydrolyzable to form a repeating unit that is —CH₂—CH(COOH)—.

In some embodiments, the protected scale inhibitor including hydrolyzably-unmaskable coordinating groups includes a (C₁-C₂₀)hydrocarbyl ester, anhydride, or substituted or unsubstituted amide of at least one of a phosphate, a phosphate ester, phosphoric acid, a phosphonate, a phosphonic acid, a sulfonate, a phosphonic acid derivative, a phosphino-polylacrylate, a phosphonic acid ethylene diamine derivative, a phosphonic acid[1,2-ethanediylbis[nitrilobis(methylene)]]tetrakis (EDTMPA), amino tris(methylenephosphonic acid) (ATMP), 1-hydroxyethane 1,1-diphosphonic acid (HEDP), triethylamine phosphate ester, diethylene triamine penta(methylene phosphonic acid), and bis(hexamethylene)triamine penta(methylenephosphonic acid). The protected scale inhibitor including hydrolyzably-unmaskable coordinating groups can be a substituted or unsubstituted (C₁-C₂₀)orthoalkanoic acid (C₁-C₂₀)hydrocarbyl ester, anhydride, or substituted or unsubstituted amide. The protected scale inhibitor including hydrolyzably-unmaskable coordinating groups can be a substituted or unsubstituted (C₁-C₂₀)orthoalkanoic acid trimethyl ester.

Herein, a salt can include any suitable cation or any suitable anion. For example, the counterion can be sodium (Na⁺), potassium (K⁺), lithium (Li⁺), hydrogen (H⁺), zinc (Zn⁺), or ammonium(NH₄⁺). In some embodiments, the counterion can have a positive charge greater than +1, which can in some embodiments complex to multiple ionized groups, such as Ca²⁺, Mg²⁺, Zn²⁺ or Al³⁺. For example, the counterion can be a halide, such as fluoro, chloro, iodo, or bromo. In other examples, the counterion can be nitrate, hydrogen sulfate, dihydrogen phosphate, bicarbonate, nitrite, perchlorate, iodate, chlorate, bromate, chlorite, hypochlorite, hypobromite, cyanide, amide, cyanate, hydroxide, permanganate. The counterion can be a conjugate base of any carboxylic acid, such as acetate or formate. In some embodiments, a counterion can have a negative charge greater than −1, which can, in some embodiments, complex to multiple ionized groups, such as oxide, sulfide, nitride, arsenate, phosphate, arsenite, hydrogen phosphate, sulfate, thiosulfate, sulfite, carbonate, chromate, dichromate, peroxide, or oxalate.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) at least one of interrupted with 0, 1, 2, or 3 groups independently substituted from —O—, substituted or unsubstittued —NH—, and —S—, a poly(substituted or unsubstituted (C₁-C₂₀)hydrocarbyloxy), and a poly(substituted or unsubstituted (C₁-C₂₀)hydrocarbylamino).

### Protective Lipophilic Phase.

In various embodiments, the composition including the scale inhibitor includes a protective lipophilic phase that encapsulates the scale inhibitor. In such an embodiment, the scale inhibitor can be any suitable scale inhibitor, such as any scale inhibitor described herein and any other scale inhibitor, or a combination thereof. By keeping the scale inhibitor out of the aqueous phase, the protective lipophilic phase can prevent or reduce the frequency with which coordinating groups in the scale inhibitor (which can at least partially bind with scale-forming ions to prevent or reduce the formation of scale) interfere with non-scale forming materials in the aqueous phase and correspondingly reduce the frequency with which the coordinating groups interfere with mechanisms dependent on those materials, such as crosslinking.

The lipophilic encapsulating phase can be any suitable nonpolar or oily phase that can be used to protect the scale inhibitor as described herein. For example, the liphophilic encapsulating phase can include at least one of crude oil, dipropylene glycol methyl ether, dipropylene glycol dimethyl ether, dipropylene glycol methyl ether, dipropylene glycol dimethyl ether, dimethyl formamide, diethylene glycol methyl ether, ethylene glycol butyl ether, diethylene glycol butyl ether, butylglycidyl ether, propylene carbonate, D-limonene, a C₂-C₄₀ fatty acid C₁-C₁₀ alkyl ester (e.g., a fatty acid methyl ester), tetrahydrofurfuryl methacrylate, tetrahydrofurfuryl acrylate, 2-butoxy ethanol, butyl acetate, butyl lactate, furfuryl acetate, dimethyl sulfoxide, dimethyl formamide, a petroleum distillation product of fraction (e.g., diesel, kerosene, napthas, and the like) mineral oil, a hydrocarbon oil, a hydrocarbon including an aromatic carbon-carbon bond (e.g., benzene, toluene), a hydrocarbon including an alpha olefin, xylenes, an ionic liquid, methyl ethyl ketone, an ester of oxalic, maleic or succinic acid, methanol, ethanol, propanol (iso- or normal-), butyl alcohol (iso-, tert-, or normal-), and an aliphatic hydrocarbon (e.g., cyclohexanone, hexane). The aqueous phase and the liphophilic phase can be an emulsion. The aqueous or lipophilic phase can be present in any suitable proportion of the total volume of the aqueous and liphophilic phases, such as about 0.01 vol % to about 99.99 vol % of the aqueous phase and the liphophilic phase, or about 20 vol % to about 80 vol % of the aqueous phase and the liphophilic phase, or about 0.01 vol % or less, or about 0.1 vol %, 1, 2, 3, 4, 5, 6, 8, 10, 12, 14, 16, 18, 20, 25, 30, 35, 40, 45, 50, 55, 60, 65, 70, 75, 80, 82, 84, 86, 88, 90, 92, 94, 96, 97, 98, 99, 99.9, or about 99.99 vol % or more.

The lipophilic phase can be sufficient such that the composition has about no decreased viscosity as compared to a corresponding composition not including the lipophilic encapsulating phase. The lipophilic encapsulating phase can be sufficient such that the composition has about 50% to about 99.999% of the viscosity of a corresponding composition not including the lipophilic encapsulating phase, or about 60% to about 99%, about 70% to about 95%, or about 50% or less, or about 55%, 60, 65, 70, 75, 80, 85, 90, 91, 92, 93, 94, 95, 96, 97, 98, 99, 99.5, 99.9, 99.99, or about 99.999% or more.

The method can include exposing the composition including the liphophilic phase to conditions in the subterranean formation such that at least some of the scale inhibitor enters the aqueous phase. The conditions sufficient to move at least some of the scale inhibitor into the aqueous phase include at least one of temperature, pressure, concentration of at least one of a salt, an oxidizing agent, a reducing agent, a mineral, a surfactant. In some embodiments, moving the scale inhibitor into the aqueous phase can include breaking the emulsion.

The scale inhibitor in the protective liphophilic phase can be any suitable scale inhibitor. For example, the scale inhibitor can include at least one of a carboxylic acid- or sulfonic acid-substituted (C₂-C₂₀)hydrocarbylene, wherein the (C₂-C₂₀)hydrocarbylene is substituted or unsubstituted, a phosphate, a phosphate ester, phosphoric acid, a phosphonate, a phosphonic acid, a polyacrylamide, an acrylamido-methyl propane sulfonate/acrylic acid copolymer (AMPS/AA), phosphinated maleic copolymer (PHOS/MA), a polymaleic acid/acrylic acid/acrylamido-methyl propane sulfonate terpolymer (PMA/AMPS), a sulfonate, a phosphonate polymer, a polyacrylic acid or an ester or amide thereof, a polymethacrylic acid or an ester or amide thereof, a polymaleic acid or an ester or amide thereof, a poly(sulfonic acid-substituted (C₂-C₂₀)alkene)) or an ester or amide thereof, a polycarboxylate, a phosphorous-containing polycarboxylate, a phosphonic acid derivative, a phosphino-polylacrylate, a phosphonic acid ethylene diamine derivative, a phosphonic acid[1,2-ethanediylbis[nitrilobis(methylene)]]tetrakis (EDTMPA), amino tris(methylenephosphonic acid) (ATMP), 1-hydroxyethane 1,1-diphosphonic acid (HEDP), triethylamine phosphate ester, diethylene triamine penta(methylene phosphonic acid), bis(hexamethylene)triamine penta(methylenephosphonic acid), a copolymer including any one of the preceding polymers or copolymers, and a salt of any one of the preceding acids or amides. The scale inhibitor can include a polymer including at least one repeating unit that is a substituted or unsubstituted ethylene unit including at least one substituent that is selected from the group consisting of a carboxylic acid, a (C₁₋₂₀)hydrocarbyl ester thereof, and a substituted or unsubstituted amide thereof. The scale inhibitor can include a polymer including repeating units derived from at least one monomer selected from the group consisting of acrylic acid, acrylic acid (C₁₋₁₀)alkyl ester, methacrylic acid, methacrylic acid (C₁₋₁₀)alkyl ester, acrylamide, methacrylamide. In various embodiments, the proportion of each type of repeating unit n a copolymer, or the percentage of esterified/amidized/salted acid units in the copolymer, can be adjusted to tune the solubility of the copolymer such that a desired one or more triggers can cause the scale inhibitor to move into the aqueous phase.

In some embodiments, emulsion polymerization can be used to fine-tune the oil solvent properties of the mixture to design the system such that a desired one or more triggers can cause the scale inhibitor to move into the aqueous phase.

### Other Components.

The composition including the scale inhibitor, optionally including a lipophilic phase protecting the scale inhibitor, or a mixture including the composition, can include any suitable additional component in any suitable proportion, such that the scale inhibitor, composition, or mixture including the same, can be used as described herein.

In some embodiments, the composition includes one or more viscosifiers. The viscosifier can be any suitable viscosifier. The viscosifier can affect the viscosity of the composition or a solvent that contacts the composition at any suitable time and location. In some embodiments, the viscosifier provides an increased viscosity at least one of before injection into the subterranean formation, at the time of injection into the subterranean formation, during travel through a tubular disposed in a borehole, once the composition reaches a particular subterranean location, or some period of time after the composition reaches a particular subterranean location. In some embodiments, the viscosifier can be about 0.000,1 wt % to about 10 wt % of the composition, about 0.004 wt % to about 0.01 wt % of the composition, or about 0.000,1 wt % or less, 0.000.5 wt %, 0.001, 0.005, 0.01, 0.05, 0.1, 0.5, 1, 2, 3, 4, 5, 6, 7, 8, 9, or about 10 wt % or more of the composition.

The viscosifier can include at least one of a substituted or unsubstituted polysaccharide, and a substituted or unsubstituted polyalkene (e.g, a polyethylene, wherein the ethylene unit is substituted or unsubstituted, derived from the corresponding substituted or unsubstituted ethene), wherein the polysaccharide or polyalkene is crosslinked or uncrosslinked. The viscosifier can include a polymer including at least one repeating unit derived from a monomer selected from the group consisting of ethylene glycol, acrylamide, vinyl acetate, 2-acrylamidomethylpropane sulfonic acid or its salts, trimethylammoniumethyl acrylate halide, and trimethylammoniumethyl methacrylate halide. The viscosifier can include a crosslinked gel or a crosslinkable gel. The viscosifier can include at least one of a linear polysaccharide, and poly((C₂-C₁₀)alkene), wherein the (C₂-C₁₀)alkene is substituted or unsubstituted. The viscosifier can include at least one of poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly (hydroxyethyl methacrylate), alginate, chitosan, curdlan, dextran, emulsan, a galactoglucopolysaccharide, gellan, glucuronan, N-acetyl-glucosamine, N-acetyl-heparosan, hyaluronic acid, kefiran, lentinan, levan, mauran, pullulan, scleroglucan, schizophyllan, stewartan, succinoglycan, xanthan, welan, derivatized starch, tamarind, tragacanth, guar gum, derivatized guar (e.g., hydroxypropyl guar, carboxy methyl guar, or carboxymethyl hydroxypropyl guar), gum ghatti, gum arabic, locust bean gum, and derivatized cellulose (e.g., carboxymethyl cellulose, hydroxyethyl cellulose, carboxymethyl hydroxyethyl cellulose, hydroxypropyl cellulose, or methyl hydroxy ethyl cellulose).

In some embodiments, the viscosifier can include at least one of a poly(vinyl alcohol) homopolymer, poly(vinyl alcohol) copolymer, a crosslinked poly(vinyl alcohol) homopolymer, and a crosslinked poly(vinyl alcohol) copolymer. The viscosifier can include a poly(vinyl alcohol) copolymer or a crosslinked poly(vinyl alcohol) copolymer including at least one of a graft, linear, branched, block, and random copolymer of vinyl alcohol and at least one of a substituted or unsubstitued (C₂-C₅₀)hydrocarbyl having at least one aliphatic unsaturated C—C bond therein, and a substituted or unsubstituted (C₂-C₅₀)alkene. The viscosifier can include a poly(vinyl alcohol) copolymer or a crosslinked poly(vinyl alcohol) copolymer including at least one of a graft, linear, branched, block, and random copolymer of vinyl alcohol and at least one of vinyl phosphonic acid, vinylidene diphosphonic acid, substituted or unsubstituted 2-acrylamido-2-methylpropanesulfonic acid, a substituted or unsubstituted (C₁-C₂₀)alkenoic acid, propenoic acid, butenoic acid, pentenoic acid, hexenoic acid, octenoic acid, nonenoic acid, decenoic acid, acrylic acid, methacrylic acid, hydroxypropyl acrylic acid, acrylamide, fumaric acid, methacrylic acid, hydroxypropyl acrylic acid, vinyl phosphonic acid, vinylidene diphosphonic acid, itaconic acid, crotonic acid, mesoconic acid, citraconic acid, styrene sulfonic acid, allyl sulfonic acid, methallyl sulfonic acid, vinyl sulfonic acid, and a substituted or unsubstituted (C₁-C₂₀)alkyl ester thereof. The viscosifier can include a poly(vinyl alcohol) copolymer or a crosslinked poly(vinyl alcohol) copolymer including at least one of a graft, linear, branched, block, and random copolymer of vinyl alcohol and at least one of vinyl acetate, vinyl propanoate, vinyl butanoate, vinyl pentanoate, vinyl hexanoate, vinyl 2-methyl butanoate, vinyl 3-ethylpentanoate, and vinyl 3-ethylhexanoate, maleic anhydride, a substituted or unsubstituted (C₁-C₂₀)alkenoic substituted or unsubstituted (C₁-C₂₀)alkanoic anhydride, a substituted or unsubstituted (C₁-C₂₀)alkenoic substituted or unsubstituted (C₁-C₂₀)alkenoic anhydride, propenoic acid anhydride, butenoic acid anhydride, pentenoic acid anhydride, hexenoic acid anhydride, octenoic acid anhydride, nonenoic acid anhydride, decenoic acid anhydride, acrylic acid anhydride, fumaric acid anhydride, methacrylic acid anhydride, hydroxypropyl acrylic acid anhydride, vinyl phosphonic acid anhydride, vinylidene diphosphonic acid anhydride, itaconic acid anhydride, crotonic acid anhydride, mesoconic acid anhydride, citraconic acid anhydride, styrene sulfonic acid anhydride, allyl sulfonic acid anhydride, methallyl sulfonic acid anhydride, vinyl sulfonic acid anhydride, and an N—(C₁-C₁₀)alkenyl nitrogen containing substituted or unsubstituted (C₁-C₁₀)heterocycle. The viscosifier can include a poly(vinyl alcohol) copolymer or a crosslinked poly(vinyl alcohol) copolymer including at least one of a graft, linear, branched, block, and random copolymer that includes a poly(vinylalcohol/acrylamide) copolymer, a poly(vinylalcohol/2-acrylamido-2-methylpropanesulfonic acid) copolymer, a poly (acrylamide/2-acrylamido-2-methylpropanesulfonic acid) copolymer, or a poly(vinylalcohol/N-vinylpyrrolidone) copolymer. The viscosifier can include a crosslinked poly(vinyl alcohol) homopolymer or copolymer including a crosslinker including at least one of chromium, aluminum, antimony, zirconium, titanium, calcium, boron, iron, silicon, copper, zinc, magnesium, and an ion thereof. The viscosifier can include a crosslinked poly(vinyl alcohol) homopolymer or copolymer including a crosslinker including at least one of an aldehyde, an aldehyde-forming compound, a carboxylic acid or an ester thereof, a sulfonic acid or an ester thereof, a phosphonic acid or an ester thereof, an acid anhydride, and an epihalohydrin.

In various embodiments, the composition can include one or more crosslinkers. The crosslinker can be any suitable crosslinker. In some examples, the crosslinker can be incorporated in a crosslinked viscosifier, and in other examples, the crosslinker can crosslink a crosslinkable material (e.g., downhole). The crosslinker can include at least one of chromium, aluminum, antimony, zirconium, titanium, calcium, boron, iron, silicon, copper, zinc, magnesium, and an ion thereof. The crosslinker can include at least one of boric acid, borax, a borate, a (C₁-C₃₀)hydrocarbylboronic acid, a (C₁-C₃₀)hydrocarbyl ester of a (C₁-C₃₀)hydrocarbylboronic acid, a (C₁-C₃₀)hydrocarbylboronic acid-modified polyacrylamide, ferric chloride, disodium octaborate tetrahydrate, sodium metaborate, sodium diborate, sodium tetraborate, disodium tetraborate, a pentaborate, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, zirconium lactate glycolate, titanium lactate, titanium malate, titanium citrate, titanium ammonium lactate, titanium triethanolamine, titanium acetylacetonate, aluminum lactate, and aluminum citrate. In some embodiments, the crosslinker can be a (C₁-C₂₀)alkylenebiacrylamide (e.g., methylenebisacrylamide), a poly((C₁-C₂₀)alkenyl)-substituted mono- or poly-(C₁-C₂₀)alkyl ether (e.g., pentaerythritol allyl ether), and a poly(C₂-C₂₀)alkenylbenzene (e.g., divinylbenzene). In some embodiments, the crosslinker can be at least one of alkyl diacrylate, ethylene glycol diacrylate, ethylene glycol dimethacrylate, polyethylene glycol diacrylate, polyethylene glycol dimethacrylate, ethoxylated bisphenol A diacrylate, ethoxylated bisphenol A dimethacrylate, ethoxylated trimethylol propane triacrylate, ethoxylated trimethylol propane trimethacrylate, ethoxylated glyceryl triacrylate, ethoxylated glyceryl trimethacrylate, ethoxylated pentaerythritol tetraacrylate, ethoxylated pentaerythritol tetramethacrylate, ethoxylated dipentaerythritol hexaacrylate, polyglyceryl monoethylene oxide polyacrylate, polyglyceryl polyethylene glycol polyacrylate, dipentaerythritol hexaacrylate, dipentaerythritol hexamethacrylate, neopentyl glycol diacrylate, neopentyl glycol dimethacrylate, pentaerythritol triacrylate, pentaerythritol trimethacrylate, trimethylol propane triacrylate, trimethylol propane trimethacrylate, tricyclodecane dimethanol diacrylate, tricyclodecane dimethanol dimethacrylate, 1,6-hexanediol diacrylate, and 1,6-hexanediol dimethacrylate. The crosslinker can be about 0.000.01 wt % to about 5 wt % of the composition, about 0.001 wt % to about 0.01 wt %, or about 0.000.01 wt % or less, or about 0.000.05 wt %, 0.000,1, 0.000,5, 0.001, 0.005, 0.01, 0.05, 0.1, 0.5, 1, 2, 3, 4, or about 5 wt % or more.

In some embodiments, the composition can include one or more breakers. The breaker can be any suitable breaker, such that the surrounding fluid (e.g., a fracturing fluid) can be at least partially broken for more complete and more efficient recovery thereof, such as at the conclusion of the hydraulic fracturing treatment. In some embodiments, the breaker can be encapsulated or otherwise formulated to give a delayed-release or a time-release, such that the surrounding liquid can remain viscous for a suitable amount of time prior to breaking. The breaker can be any suitable breaker; for example, the breaker can be a compound that includes a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a chloride, fluoride, bromide, phosphate, or sulfate ion. In some examples, the breaker can be an oxidative breaker or an enzymatic breaker. An oxidative breaker can be at least one of a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a persulfate, percarbonate, perborate, peroxide, perphosphosphate, permanganate, chlorite, or hyperchlorite ion. An enzymatic breaker can be at least one of an alpha or beta amylase, amyloglucosidase, oligoglucosidase, invertase, maltase, cellulase, hemi-cellulase, and mannanohydrolase. The breaker can be about 0.001 wt % to about 30 wt % of the composition, or about 0.01 wt % to about 5 wt %, or about 0.001 wt % or less, or about 0.005 wt %, 0.01, 0.05, 0.1, 0.5, 1, 2, 3, 4, 5, 6, 8, 10, 12, 14, 16, 18, 20, 22, 24, 26, 28, or about 30 wt % or more.

The composition, or a mixture including the composition, can include any suitable fluid. For example, the fluid can be at least one of crude oil, dipropylene glycol methyl ether, dipropylene glycol dimethyl ether, dipropylene glycol methyl ether, dipropylene glycol dimethyl ether, dimethyl formamide, diethylene glycol methyl ether, ethylene glycol butyl ether, diethylene glycol butyl ether, butylglycidyl ether, propylene carbonate, D-limonene, a C₂-C₄₀ fatty acid C₁-C₁₀ alkyl ester (e.g., a fatty acid methyl ester), tetrahydrofurfuryl methacrylate, tetrahydrofurfuryl acrylate, 2-butoxy ethanol, butyl acetate, butyl lactate, furfuryl acetate, dimethyl sulfoxide, dimethyl formamide, a petroleum distillation product of fraction (e.g., diesel, kerosene, napthas, and the like) mineral oil, a hydrocarbon oil, a hydrocarbon including an aromatic carbon-carbon bond (e.g., benzene, toluene), a hydrocarbon including an alpha olefin, xylenes, an ionic liquid, methyl ethyl ketone, an ester of oxalic, maleic or succinic acid, methanol, ethanol, propanol (iso- or normal-), butyl alcohol (iso-, tert-, or normal-), an aliphatic hydrocarbon (e.g., cyclohexanone, hexane), water, brine, produced water, flowback water, brackish water, and sea water. The fluid can form about 0.001 wt % to about 99.999 wt % of the composition or a mixture including the same, or about 0.001 wt % or less, 0.01 wt %, 0.1, 1, 2, 3, 4, 5, 6, 8, 10, 15, 20, 25, 30, 35, 40, 45, 50, 55, 60, 65, 70, 75, 80, 85, 90, 95, 96, 97, 98, 99, 99.9, 99.99, or about 99.999 wt % or more.

The composition including the scale inhibitor can include any suitable downhole fluid. The composition including the scale inhibitor can be combined with any suitable downhole fluid before, during, or after the placement of the composition in the subterranean formation or the contacting of the composition and the subterranean material. In some examples, the composition including the scale inhibitor is combined with a downhole fluid above the surface, and then the combined composition is placed in a subterranean formation or contacted with a subterranean material. In another example, the composition including the scale inhibitor is injected into a subterranean formation to combine with a downhole fluid, and the combined composition is contacted with a subterranean material or is considered to be placed in the subterranean formation. In various examples, at least one of prior to, during, and after the placement of the composition in the subterranean formation or contacting of the subterranean material and the composition, the composition is used in the subterranean formation (e.g., downhole), at least one of alone and in combination with other materials, as a drilling fluid, stimulation fluid, fracturing fluid, spotting fluid, clean-up fluid, completion fluid, remedial treatment fluid, abandonment fluid, pill, acidizing fluid, cementing fluid, packer fluid, or a combination thereof.

In various embodiments, the composition including the scale inhibitor or a mixture including the same can include any suitable downhole fluid, such as an aqueous or oil-based fluid including a drilling fluid, stimulation fluid, fracturing fluid, spotting fluid, clean-up fluid, completion fluid, remedial treatment fluid, abandonment fluid, pill, acidizing fluid, cementing fluid, packer fluid, or a combination thereof. The placement of the composition in the subterranean formation can include contacting the subterranean material and the mixture. Any suitable weight percent of the composition or of a mixture including the same that is placed in the subterranean formation or contacted with the subterranean material can be the downhole fluid, such as about 0.001 wt % to about 99.999 wt %, about 0.01 wt % to about 99.99 wt %, about 0.1 wt % to about 99.9 wt %, about 20 wt % to about 90 wt %, or about 0.001 wt % or less, or about 0.01 wt %, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99 wt %, or about 99.999 wt % or more of the composition or mixture including the same.

In some embodiments, the composition or a mixture including the same can include any suitable amount of any suitable material used in a downhole fluid. For example, the composition can include water, saline, aqueous base, acid, oil, organic solvent, synthetic fluid oil phase, aqueous solution, alcohol or polyol, cellulose, starch, alkalinity control agents, acidity control agents, density control agents, density modifiers, emulsifiers, dispersants, polymeric stabilizers, crosslinking agents, polyacrylamide, a polymer or combination of polymers, antioxidants, heat stabilizers, foam control agents, solvents, diluents, plasticizer, filler or inorganic particle, pigment, dye, precipitating agent, rheology modifier, oil-wetting agents, set retarding additives, surfactants, gases, weight reducing additives, heavy-weight additives, lost circulation materials, filtration control additives, salts, fibers, thixotropic additives, breakers, crosslinkers, rheology modifiers, curing accelerators, curing retarders, pH modifiers, chelating agents, scale inhibitors, enzymes, resins, water control materials, oxidizers, markers, Portland cement, pozzolana cement, gypsum cement, high alumina content cement, slag cement, silica cement, fly ash, metakaolin, shale, zeolite, a crystalline silica compound, amorphous silica, hydratable clays, microspheres, pozzolan lime, or a combination thereof. In various embodiments, the composition can include one or more additive components such as: thinner additives such as COLDTROL®, ATC®, OMC 2™ and OMC 42™; RHEMOD™, a viscosifier and suspension agent including a modified fatty acid; additives for providing temporary increased viscosity, such as for shipping (e.g., transport to the well site) and for use in sweeps (for example, additives having the trade name TEMPERUS™ (a modified fatty acid) and VIS-PLUS®, a thixotropic viscosifying polymer blend); TAU-MOD™, a viscosifying/suspension agent including an amorphous/fibrous material; additives for filtration control, for example, ADAPTA®, a high temperature high pressure (HTHP) filtration control agent including a crosslinked copolymer; DURATONE® HT, a filtration control agent that includes an organophilic lignite, more particularly organophilic leonardite; THERMO TONE™, a HTHP filtration control agent including a synthetic polymer; BDF™-366, a HTHP filtration control agent; BDF™-454, a HTHP filtration control agent; LIQUITONE™, a polymeric filtration agent and viscosifier; additives for HTHP emulsion stability, for example, FACTANT™, which includes highly concentrated tall oil derivative; emulsifiers such as LE SUPERMUL™ and EZ MUL® NT, polyaminated fatty acid emulsifiers, and FORTI-MUL®; DRIL TREAT®, an oil wetting agent for heavy fluids; BARACARB®, a sized ground marble bridging agent; BAROID®, a ground barium sulfate weighting agent; BAROLIFT®, a hole sweeping agent; SWEEP-WATE®, a sweep weighting agent; BDF-508, a diamine dimer rheology modifier; GELTONE® II organophilic clay; BAROFIBRE™ 0 for lost circulation management and seepage loss prevention, including a natural cellulose fiber; STEELSEAL®, a resilient graphitic carbon lost circulation material; HYDRO-PLUG®, a hydratable swelling lost circulation material; lime, which can provide alkalinity and can activate certain emulsifiers; and calcium chloride, which can provide salinity. Any suitable proportion of the composition or mixture including the composition can include any optional component listed in this paragraph, such as about 0.001 wt % to about 99.999 wt %, about 0.01 wt % to about 99.99 wt %, about 0.1 wt % to about 99.9 wt %, about 20 to about 90 wt %, or about 0.001 wt % or less, or about 0.01 wt %, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99 wt %, or about 99.999 wt % or more of the composition or mixture.

A drilling fluid, also known as a drilling mud or simply “mud,” is a specially designed fluid that is circulated through a wellbore as the wellbore is being drilled to facilitate the drilling operation. The drilling fluid can be water-based or oil-based. The drilling fluid can carry cuttings up from beneath and around the bit, transport them up the annulus, and allow their separation. Also, a drilling fluid can cool and lubricate the drill head as well as reduce friction between the drill string and the sides of the hole. The drilling fluid aids in support of the drill pipe and drill head, and provides a hydrostatic head to maintain the integrity of the wellbore walls and prevent well blowouts. Specific drilling fluid systems can be selected to optimize a drilling operation in accordance with the characteristics of a particular geological formation. The drilling fluid can be formulated to prevent unwanted influxes of formation fluids from permeable rocks and also to form a thin, low permeability filter cake that temporarily seals pores, other openings, and formations penetrated by the bit. In water-based drilling fluids, solid particles are suspended in a water or brine solution containing other components. Oils or other non-aqueous liquids can be emulsified in the water or brine or at least partially solubilized (for less hydrophobic non-aqueous liquids), but water is the continuous phase. A drilling fluid can be present in the mixture with the composition including the scale inhibitor in any suitable amount, such as about 1 wt % or less, about 2 wt %, 3, 4, 5, 10, 15, 20, 30, 40, 50, 60, 70, 80, 85, 90, 95, 96, 97, 98, 99, 99.9, 99.99, or about 99.999 wt % or more of the mixture.

A water-based drilling fluid in embodiments of the present invention can be any suitable water-based drilling fluid. In various embodiments, the drilling fluid can include at least one of water (fresh or brine), a salt (e.g., calcium chloride, sodium chloride, potassium chloride, magnesium chloride, calcium bromide, sodium bromide, potassium bromide, calcium nitrate, sodium formate, potassium formate, cesium formate), aqueous base (e.g., sodium hydroxide or potassium hydroxide), alcohol or polyol, cellulose, starches, alkalinity control agents, density control agents such as a density modifier (e.g., barium sulfate), surfactants (e.g., betaines, alkali metal alkylene acetates, sultaines, ether carboxylates), emulsifiers, dispersants, polymeric stabilizers, crosslinking agents, polyacrylamides, polymers or combinations of polymers, antioxidants, heat stabilizers, foam control agents, solvents, diluents, plasticizers, filler or inorganic particles (e.g., silica), pigments, dyes, precipitating agents (e.g., silicates or aluminum complexes), and rheology modifiers such as thickeners or viscosifiers (e.g., xanthan gum). Any ingredient listed in this paragraph can be either present or not present in the mixture.

An oil-based drilling fluid or mud in embodiments of the present invention can be any suitable oil-based drilling fluid. In various embodiments, the drilling fluid can include at least one of an oil-based fluid (or synthetic fluid), saline, aqueous solution, emulsifiers, other agents or additives for suspension control, weight or density control, oil-wetting agents, fluid loss or filtration control agents, and rheology control agents. For example, see H. C. H. Darley and George R. Gray, Composition and Properties of Drilling and Completion Fluids 66-67, 561-562 (5^{th} ed. 1988). An oil-based or invert emulsion-based drilling fluid can include between about 10:90 to about 95:5, or about 50:50 to about 95:5, by volume of oil phase to water phase. A substantially all oil mud includes about 100% liquid phase oil by volume (e.g., substantially no internal aqueous phase).

A pill is a relatively small quantity (e.g., less than about 500 bbl, or less than about 200 bbl) of drilling fluid used to accomplish a specific task that the regular drilling fluid cannot perform. For example, a pill can be a high-viscosity pill to, for example, help lift cuttings out of a vertical wellbore. In another example, a pill can be a freshwater pill to, for example, dissolve a salt formation. Another example is a pipe-freeing pill to, for example, destroy filter cake and relieve differential sticking forces. In another example, a pill is a lost circulation material pill to, for example, plug a thief zone. A pill can include any component described herein as a component of a drilling fluid.

A cement fluid can include an aqueous mixture of at least one of cement and cement kiln dust. The composition including the scale inhibitor can form a useful combination with cement or cement kiln dust. The cement kiln dust can be any suitable cement kiln dust. Cement kiln dust can be formed during the manufacture of cement and can be partially calcined kiln feed that is removed from the gas stream and collected in a dust collector during a manufacturing process. Cement kiln dust can be advantageously utilized in a cost-effective manner since kiln dust is often regarded as a low value waste product of the cement industry. Some embodiments of the cement fluid can include cement kiln dust but no cement, cement kiln dust and cement, or cement but no cement kiln dust. The cement can be any suitable cement. The cement can be a hydraulic cement. A variety of cements can be utilized in accordance with embodiments of the present invention; for example, those including calcium, aluminum, silicon, oxygen, iron, or sulfur, which can set and harden by reaction with water. Suitable cements can include Portland cements, pozzolana cements, gypsum cements, high alumina content cements, slag cements, silica cements, and combinations thereof. In some embodiments, the Portland cements that are suitable for use in embodiments of the present invention are classified as Classes A, C, H, and G cements according to the American Petroleum Institute, API Specification for Materials and Testing for Well Cements, API Specification 10, Fifth Ed., Jul. 1, 1990. A cement can be generally included in the cementing fluid in an amount sufficient to provide the desired compressive strength, density, or cost. In some embodiments, the hydraulic cement can be present in the cementing fluid in an amount in the range of from 0 wt % to about 100 wt %, about 0 wt % to about 95 wt %, about 20 wt % to about 95 wt %, or about 50 wt % to about 90 wt %. A cement kiln dust can be present in an amount of at least about 0.01 wt %, or about 5 wt % to about 80 wt %, or about 10 wt % to about 50 wt %.

Optionally, other additives can be added to a cement or kiln dust-containing composition of embodiments of the present invention as deemed appropriate by one skilled in the art, with the benefit of this disclosure. Any optional ingredient listed in this paragraph can be either present or not present in the composition. For example, the composition can include fly ash, metakaolin, shale, zeolite, set retarding additive, surfactant, a gas, accelerators, weight reducing additives, heavy-weight additives, lost circulation materials, filtration control additives, dispersants, and combinations thereof. In some examples, additives can include crystalline silica compounds, amorphous silica, salts, fibers, hydratable clays, microspheres, pozzolan lime, thixotropic additives, combinations thereof, and the like.

In various embodiments, the composition or mixture can include a proppant, a resin-coated proppant, an encapsulated resin, or a combination thereof. A proppant is a material that keeps an induced hydraulic fracture at least partially open during or after a fracturing treatment. Proppants can be transported into the subterranean formation (e.g., downhole) to the fracture using fluid, such as fracturing fluid or another fluid. A higher-viscosity fluid can more effectively transport proppants to a desired location in a fracture, especially larger proppants, by more effectively keeping proppants in a suspended state within the fluid. Examples of proppants can include sand, gravel, glass beads, polymer beads, ground products from shells and seeds such as walnut hulls, and manmade materials such as ceramic proppant, bauxite, tetrafluoroethylene materials (e.g., TEFLON™ available from DuPont), fruit pit materials, processed wood, composite particulates prepared from a binder and fine grade particulates such as silica, alumina, fumed silica, carbon black, graphite, mica, titanium dioxide, meta-silicate, calcium silicate, kaolin, talc, zirconia, boron, fly ash, hollow glass microspheres, and solid glass, or mixtures thereof. In some embodiments, the proppant can have an average particle size, wherein particle size is the largest dimension of a particle, of about 0.001 mm to about 3 mm, about 0.15 mm to about 2.5 mm, about 0.25 mm to about 0.43 mm, about 0.43 mm to about 0.85 mm, about 0.85 mm to about 1.18 mm, about 1.18 mm to about 1.70 mm, or about 1.70 to about 2.36 mm. In some embodiments, the proppant can have a distribution of particle sizes clustering around multiple averages, such as one, two, three, or four different average particle sizes. The composition or mixture can include any suitable amount of proppant, such as about 0.01 wt % to about 99.99 wt %, about 0.1 wt % to about 80 wt %, about 10 wt % to about 60 wt %, or about 0.01 wt % or less, or about 0.1 wt %, 1, 2, 3, 4, 5, 10, 15, 20, 30, 40, 50, 60, 70, 80, 85, 90, 91, 92, 93, 94, 95, 96, 97, 98, 99, about 99.9 wt %, or about 99.99 wt % or more.

### Drilling Assembly.

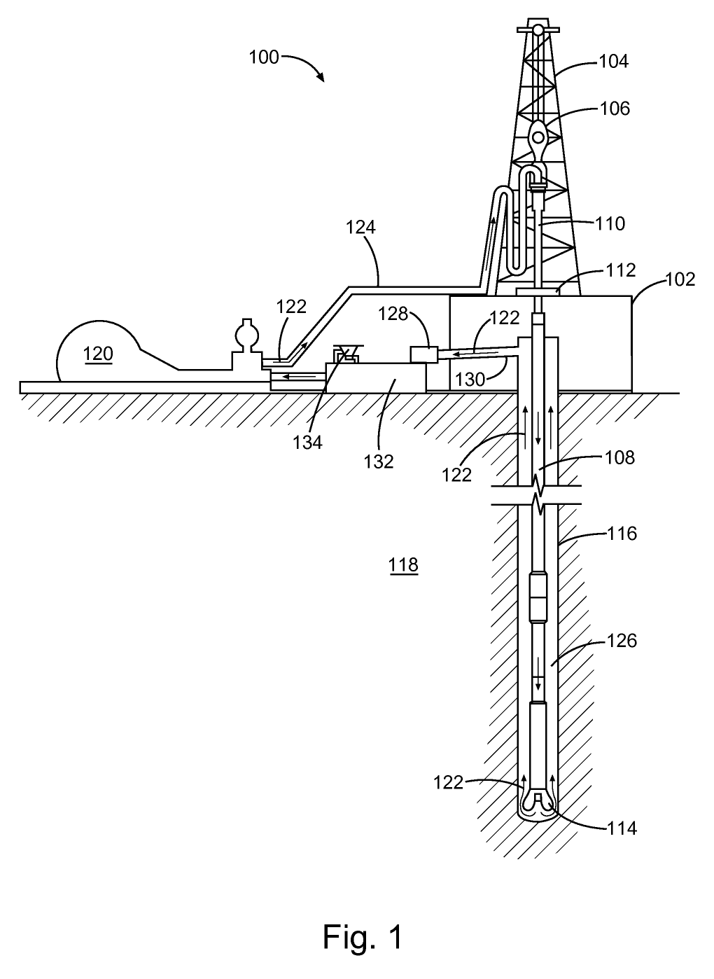

In various embodiments, the composition including the scale inhibitor disclosed herein can directly or indirectly affect one or more components or pieces of equipment associated with the preparation, delivery, recapture, recycling, reuse, and/or disposal of the disclosed composition including the scale inhibitor and optionally including a protective liphophilic phase. For example, and with reference to FIG. 1, the disclosed composition including the scale inhibitor can directly or indirectly affect one or more components or pieces of equipment associated with an exemplary wellbore drilling assembly 100, according to one or more embodiments. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 can include a drilling platform 102 that supports a derrick 104 having a traveling block 106 for raising and lowering a drill string 108. The drill string 108 can include drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a wellbore 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the wellbore 116. At the surface, the recirculated or spent drilling fluid 122 exits the annulus 126 and can be conveyed to one or more fluid processing unit(s) 128 via an interconnecting flow line 130. After passing through the fluid processing unit(s) 128, a “cleaned” drilling fluid 122 is deposited into a nearby retention pit 132 (e.g., a mud pit). While illustrated as being arranged at the outlet of the wellbore 116 via the annulus 126, those skilled in the art will readily appreciate that the fluid processing unit(s) 128 can be arranged at any other location in the drilling assembly 100 to facilitate its proper function, without departing from the scope of the disclosure.

The composition including the scale inhibitor can be added to the drilling fluid 122 via a mixing hopper 134 communicably coupled to or otherwise in fluid communication with the retention pit 132. The mixing hopper 134 can include mixers and related mixing equipment known to those skilled in the art. In other embodiments, however, the composition including the scale inhibitor can be added to the drilling fluid 122 at any other location in the drilling assembly 100. In at least one embodiment, for example, there could be more than one retention pit 132, such as multiple retention pits 132 in series. Moreover, the retention pit 132 can be representative of one or more fluid storage facilities and/or units where the composition including the scale inhibitor can be stored, reconditioned, and/or regulated until added to the drilling fluid 122.

As mentioned above, the composition including the scale inhibitor can directly or indirectly affect the components and equipment of the drilling assembly 100. For example, the composition including the scale inhibitor can directly or indirectly affect the fluid processing unit(s) 128, which can include one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, or any fluid reclamation equipment. The fluid processing unit(s) 128 can further include one or more sensors, gauges, pumps, compressors, and the like used to store, monitor, regulate, and/or recondition the composition including the scale inhibitor.

The composition including the scale inhibitor can directly or indirectly affect the pump 120, which representatively includes any conduits, pipelines, trucks, tubulars, and/or pipes used to fluidically convey the composition including the scale inhibitor to the subterranean formation, any pumps, compressors, or motors (e.g., topside or downhole) used to drive the composition into motion, any valves or related joints used to regulate the pressure or flow rate of the composition, and any sensors (e.g., pressure, temperature, flow rate, and the like), gauges, and/or combinations thereof, and the like. The composition including the scale inhibitor can also directly or indirectly affect the mixing hopper 134 and the retention pit 132 and their assorted variations.

The composition including the scale inhibitor can also directly or indirectly affect the various downhole or subterranean equipment and tools that can come into contact with the composition including the scale inhibitor such as the drill string 108, any floats, drill collars, mud motors, downhole motors, and/or pumps associated with the drill string 108, and any measurement while drilling (MWD)/logging while drilling (LWD) tools and related telemetry equipment, sensors, or distributed sensors associated with the drill string 108. The composition including the scale inhibitor can also directly or indirectly affect any downhole heat exchangers, valves and corresponding actuation devices, tool seals, packers and other wellbore isolation devices or components, and the like associated with the wellbore 116. The composition including the scale inhibitor can also directly or indirectly affect the drill bit 114, which can include roller cone bits, polycrystalline diamond compact (PDC) bits, natural diamond bits, any hole openers, reamers, coring bits, and the like.

While not specifically illustrated herein, the composition including the scale inhibitor can also directly or indirectly affect any transport or delivery equipment used to convey the composition including the scale inhibitor to the drilling assembly 100 such as, for example, any transport vessels, conduits, pipelines, trucks, tubulars, and/or pipes used to fluidically move the composition including the scale inhibitor from one location to another, any pumps, compressors, or motors used to drive the composition into motion, any valves or related joints used to regulate the pressure or flow rate of the composition, and any sensors (e.g., pressure and temperature), gauges, and/or combinations thereof, and the like.

### System or Apparatus.

In various embodiments, the present invention provides a system. The system can be any suitable system that can use or that can be generated by use of an embodiment of the composition described herein in a subterranean formation, or that can perform or be generated by performance of a method for using the composition described herein. The system can include a composition including a scale inhibitor, such as any scale inhibitor described herein, optionally protectively encapsulated by a lipophilic phase. In some embodiments, the system can include a composition that includes a protective lipophilic phase and any suitable scale inhibitor. The system can also include a subterranean formation including the composition therein. In some embodiments, the composition in the system can also include a downhole fluid, or the system can include a mixture of the composition and downhole fluid. In some embodiments, the system can include a tubular, and a pump configured to pump the composition into the subterranean formation through the tubular.

Various embodiments provide systems and apparatus configured for delivering the composition described herein to a subterranean location and for using the composition therein, such as for a drilling operation, or a fracturing operation (e.g., pre-pad, pad, slurry, or finishing stages). In various embodiments, the system or apparatus can include a pump fluidly coupled to a tubular (e.g., any suitable type of oilfield pipe, such as pipeline, drill pipe, production tubing, and the like), the tubular containing a composition including a scale inhibitor, such as any scale inhibitor described herein, optionally protectively encapsulated by a lipophilic phase.

In some embodiments, the system can include a drillstring disposed in a wellbore, the drillstring including a drill bit at a downhole end of the drillstring. The system can also include an annulus between the drillstring and the wellbore. The system can also include a pump configured to circulate the composition through the drill string, through the drill bit, and back above-surface through the annulus. In some embodiments, the system can include a fluid processing unit configured to process the composition exiting the annulus to generate a cleaned drilling fluid for recirculation through the wellbore.

In various embodiments, the present invention provides an apparatus. The apparatus can be any suitable apparatus that can use or that can be generated by use of the composition described herein in a subterranean formation, or that can perform or be generated by performance of a method for using the composition described herein.

The pump can be a high pressure pump in some embodiments. As used herein, the term “high pressure pump” will refer to a pump that is capable of delivering a fluid to a subterranean formation (e.g., downhole) at a pressure of about 1000 psi or greater. A high pressure pump can be used when it is desired to introduce the composition to a subterranean formation at or above a fracture gradient of the subterranean formation, but it can also be used in cases where fracturing is not desired. In some embodiments, the high pressure pump can be capable of fluidly conveying particulate matter, such as proppant particulates, into the subterranean formation. Suitable high pressure pumps will be known to one having ordinary skill in the art and can include floating piston pumps and positive displacement pumps.

In other embodiments, the pump can be a low pressure pump. As used herein, the term “low pressure pump” will refer to a pump that operates at a pressure of about 1000 psi or less. In some embodiments, a low pressure pump can be fluidly coupled to a high pressure pump that is fluidly coupled to the tubular. That is, in such embodiments, the low pressure pump can be configured to convey the composition to the high pressure pump. In such embodiments, the low pressure pump can “step up” the pressure of the composition before it reaches the high pressure pump.

In some embodiments, the systems or apparatuses described herein can further include a mixing tank that is upstream of the pump and in which the composition is formulated. In various embodiments, the pump (e.g., a low pressure pump, a high pressure pump, or a combination thereof) can convey the composition from the mixing tank or other source of the composition to the tubular. In other embodiments, however, the composition can be formulated offsite and transported to a worksite, in which case the composition can be introduced to the tubular via the pump directly from its shipping container (e.g., a truck, a railcar, a barge, or the like) or from a transport pipeline. In either case, the composition can be drawn into the pump, elevated to an appropriate pressure, and then introduced into the tubular for delivery to the subterranean formation.

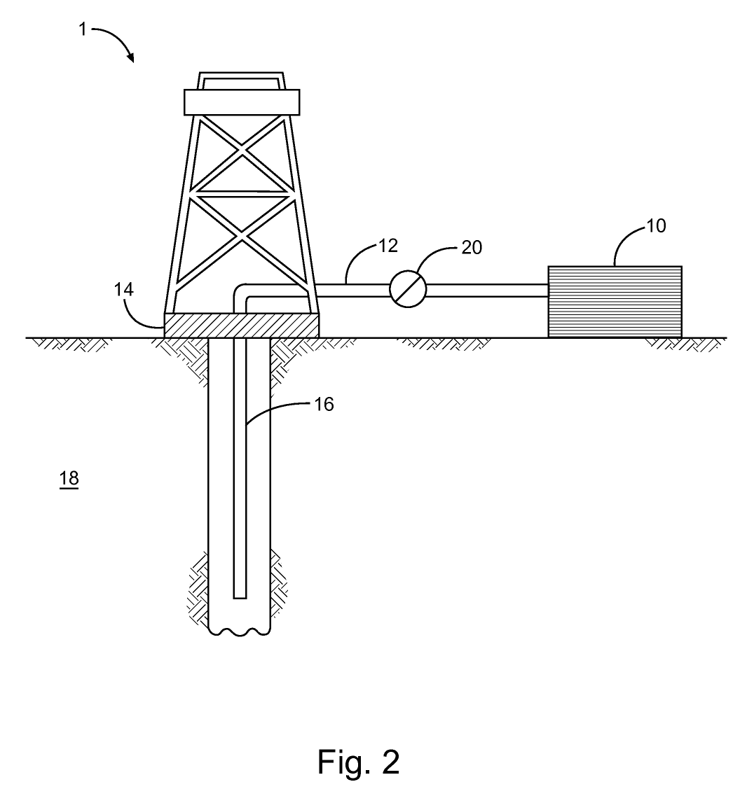

FIG. 2 shows an illustrative schematic of systems and apparatuses that can deliver embodiments of the compositions of the present invention to a subterranean location, according to one or more embodiments. It should be noted that while FIG. 2 generally depicts a land-based system or apparatus, it is to be recognized that like systems and apparatuses can be operated in subsea locations as well. Embodiments of the present invention can have a different scale than that depicted in FIG. 2. As depicted in FIG. 2, system or apparatus 1 can include mixing tank 10, in which an embodiment of the composition can be formulated. The composition can be conveyed via line 12 to wellhead 14, where the composition enters tubular 16, with tubular 16 extending from wellhead 14 into subterranean formation 18. Upon being ejected from tubular 16, the composition can subsequently penetrate into subterranean formation 18. Pump 20 can be configured to raise the pressure of the composition to a desired degree before its introduction into tubular 16. It is to be recognized that system or apparatus 1 is merely exemplary in nature and various additional components can be present that have not necessarily been depicted in FIG. 2 in the interest of clarity. In some examples, additional components that can be present include supply hoppers, valves, condensers, adapters, joints, gauges, sensors, compressors, pressure controllers, pressure sensors, flow rate controllers, flow rate sensors, temperature sensors, and the like.

Although not depicted in FIG. 2, at least part of the composition can, in some embodiments, flow back to wellhead 14 and exit subterranean formation 18. The composition that flows back can be substantially diminished in the concentration of the scale inhibitor, or can have no scale inhibitor therein. In some embodiments, the composition that has flowed back to wellhead 14 can subsequently be recovered, and in some examples reformulated, and recirculated to subterranean formation 18.

It is also to be recognized that the disclosed composition can also directly or indirectly affect the various downhole or subterranean equipment and tools that can come into contact with the composition during operation. Such equipment and tools can include wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, and the like), logging tools and related telemetry equipment, actuators (e.g., electromechanical devices, hydromechanical devices, and the like), sliding sleeves, production sleeves, plugs, screens, filters, flow control devices (e.g., inflow control devices, autonomous inflow control devices, outflow control devices, and the like), couplings (e.g., electro-hydraulic wet connect, dry connect, inductive coupler, and the like), control lines (e.g., electrical, fiber optic, hydraulic, and the like), surveillance lines, drill bits and reamers, sensors or distributed sensors, downhole heat exchangers, valves and corresponding actuation devices, tool seals, packers, cement plugs, bridge plugs, and other wellbore isolation devices or components, and the like. Any of these components can be included in the systems and apparatuses generally described above and depicted in FIG. 2.

### Composition for Treatment of a Subterranean Formation.

Various embodiments provide a composition for treatment of a subterranean formation. The composition can be any suitable composition that can be used to perform an embodiment of the method for treatment of a subterranean formation described herein. The composition can be any composition that includes an embodiment of a scale inhibitor described herein, optionally including a liphophilic protective phase. In some embodiments, the composition can include a protective lipophilic phase and any suitable scale inhibitor.

In some embodiments, the composition further includes a downhole fluid. The downhole fluid can be any suitable downhole fluid. In some embodiments, the downhole fluid is a composition for fracturing of a subterranean formation or subterranean material, or a fracturing fluid.

### Method for Preparing a Composition for Treatment of a Subterranean Formation.

In various embodiments, the present invention provides a method for preparing a composition for treatment of a subterranean formation. The method can be any suitable method that produces a composition described herein. For example, the method can include forming a composition including an embodiment of the scale inhibitor described herein, optionally including a protective lipophilic phase. In some embodiments, the composition can include a protective lipophilic phase and any suitable scale inhibitor.

### EXAMPLES

Various embodiments of the present invention can be better understood by reference to the following Examples which are offered by way of illustration. The present invention is not limited to the Examples given herein.

### Example 1. Zirconium-crosslinked hydroxypropyl guar (HPG)

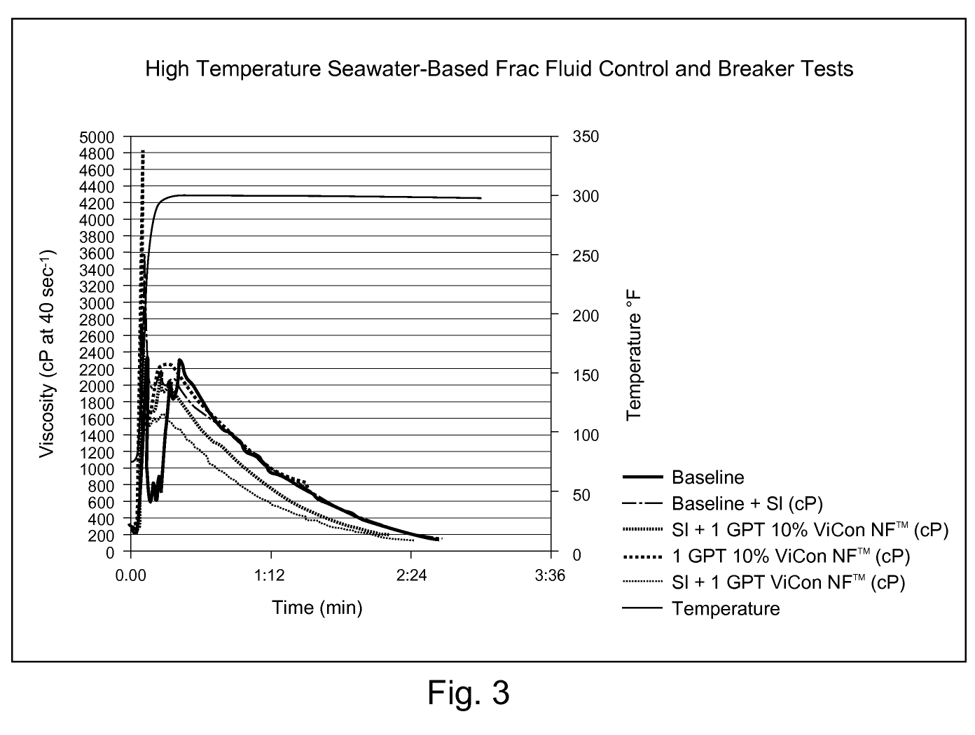

A Zr-crosslinked HPG fracturing fluid was made using seawater and including 0.2 gallons per thousand gallons (gpt) BA-20™ (a buffering agent), 2.0 gpt GasPerm 1000M™ (a surfactant), 50 pounds per thousand gallons (ppt) of a hydroxypropylguar gelling agent, 9.0 gpt GelSta L™ (a high-temperature gel stabilizer), 1.75 gpt BA-40L™ (a buffering agent), and 0.35 gpt of a zirconium-based crosslinker (baseline sample). The average base gel pH of the baseline sample was 6.75. The average XL pH was 9.2 (the pH of the solutions before crosslinking). The average final pH was 8.40 (pH after crosslinking, averaged across all the samples). The viscosity of the baseline sample at 40 seconds⁻¹ was 52 cP. A sample of the fracturing fluid was made that included 4 gallons per thousand gallons (gal/Mgal) of sodium allylsulfonate/maleic acid copolymer scale inhibitor (baseline+SI), wherein the copolymer had an average molecular weight of about 3000 g/mol, about 60-80 mol % repeating units derived from sodium allylsulfonate monomers, and about 20-40 mol % repeating units derived from maleic acid monomers. A sample of the fracturing fluid was made that included 4 gal/Mgal of the copolymer scale inhibitor and 1 gpt 10 wt % in water ViCon NF™ breaker (SI+1 gpt 10% ViCon NF™). A sample of the fracturing fluid was made that included none of the scale inhibitor but included 1 gpt 10 wt % ViCon NF™ breaker (1 gpt ViCon NF™). A sample of the fracturing fluid was made that included 4 gal/Mgal of the copolymer scale inhibitor and 1 gpt ViCon NF™ breaker (SI+1 gpt ViCon NF™). The viscosity of the samples over time at 40 seconds⁻¹ was measured with heating to about 300° F., with the results shown in FIG. 3. The addition of the scale inhibitor polymer did not affect the crosslinking and the breaking performance of the polymer.

### Example 2. Aluminum/Zirconium-Crosslinked Carboxymethyl Hydroxyethylcellulose (CMHEC)

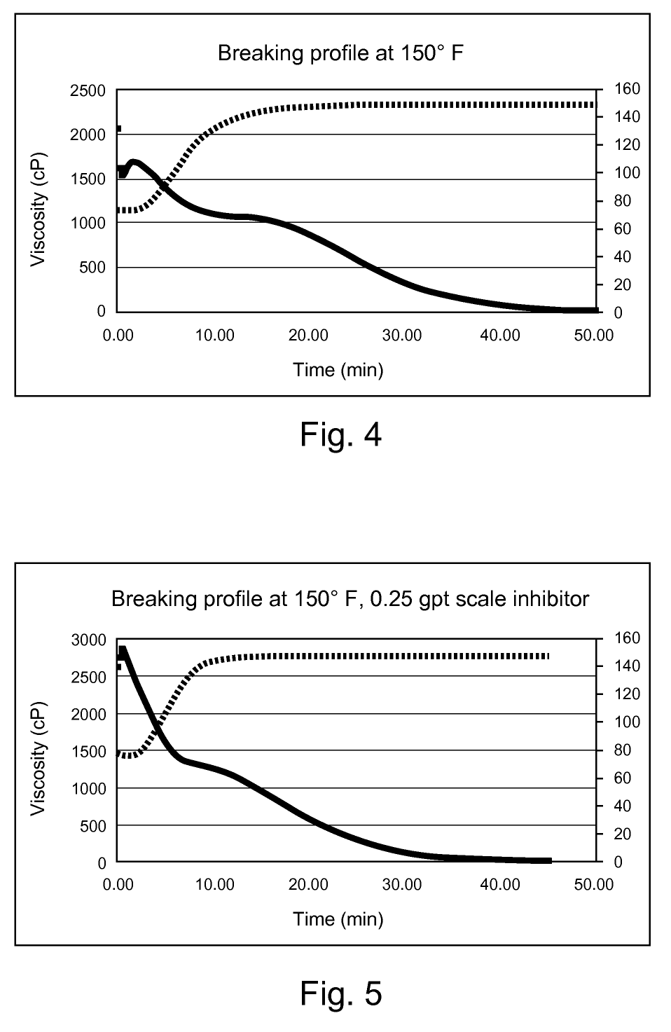

An Al/Zr-crosslinked CMHEC fracturing fluid was made using seawater and including 35 lb/Mgal CMHEC, 0.375 gpt Al crosslinker, 0.3275 Zr crosslinker, 0.25 gpt BA-20™ buffering agent, 3 gpt ViCon NF™ (1.2% w/v), 4 ppt encapsulated breaker. Another sample was made by adding the sodium allylsulfonate/maleic acid copolymer scale inhibitor from Example 1 into the fracturing fluid at 0.25 gal/Mgal concentration. The viscosity of the sample was measured at 40 seconds⁻¹ with heating to about 150° F. FIG. 4 illustrates the viscosity of the Al/Zr-crosslinked CMHEC fracturing fluid sample without the scale inhibitor. FIG. 5 illustrates the viscosity of the Al/Zr-crosslinked CMHEC fracturing fluid sample with the scale inhibitor. The addition of the scale inhibitor polymer did not affect the crosslinking performance of the polymer.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments

The following exemplary embodiments are provided, the numbering of which is not to be construed as designating levels of importance:

Embodiment 1 provides a method of treating a subterranean formation, the method comprising:

obtaining or providing a composition comprising a scale inhibitor, wherein at least one of A and B:
A) the scale inhibitor comprises at least one of
   a copolymer comprising a repeating unit comprising at least one sulfonic acid or sulfonate group and a repeating unit comprising at least two carboxylic acid or carboxylate groups; and
   a protected scale inhibitor comprising hydrolyzably-unmaskable coordinating groups;
B) the composition comprises an aqueous phase and a lipophilic phase, wherein the lipophilic phase protectively encapsulates the scale inhibitor; and

placing the composition in a subterranean formation.

Embodiment 2 provides the method of Embodiment 1, wherein the obtaining or providing of the composition occurs above-surface.

Embodiment 3 provides the method of any one of Embodiments 1-2, wherein the obtaining or providing of the composition occurs in the subterranean formation.

Embodiment 4 provides the method of any one of Embodiments 1-3, wherein the composition is a composition for hydraulic fracturing.

Embodiment 5 provides the method of any one of Embodiments 1-4, wherein the composition comprises fracturing fluid.

Embodiment 6 provides the method of any one of Embodiments 1-5, wherein about 0.001 wt % to about 100 wt % of the composition is the scale inhibitor.

Embodiment 7 provides the method of any one of Embodiments 1-6, wherein about 0.01 wt % to about 5 wt % the composition is the scale inhibitor.

Embodiment 8 provides the method of any one of Embodiments 1-7, wherein the scale inhibitor is sufficient such that the composition has about 50% to about 99.999% of the viscosity of a corresponding composition not including the scale inhibitor.

Embodiment 9 provides the method of any one of Embodiments 1-8, wherein the scale inhibitor is sufficient such that the composition has about no decreased viscosity as compared to a corresponding composition not including the scale inhibitor.

Embodiment 10 provides the method of any one of Embodiments 1-9, wherein the lipophilic encapsulating phase is sufficient such that the composition has about 50% to about 99.999% of the viscosity of a corresponding composition not including the lipophilic encapsulating phase.

Embodiment 11 provides the method of any one of Embodiments 1-10, wherein the lipophilic encapsulating phase is sufficient such that the composition has about no decreased viscosity as compared to a corresponding composition not including the lipophilic encapsulating phase.

Embodiment 12 provides the method of any one of Embodiments 1-11, wherein the scale inhibitor comprises repeating units having the structure:

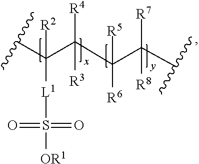

wherein
the repeating units are in block or random copolymer arrangement and, at each occurrence, independently occur in the direction shown or in the opposite direction,
at each occurrence, each of R², R³, R⁴, R⁵, R⁶, R⁷, and R⁸ is independently selected from the group consisting of —H and substituted or unsubstituted (C₁-C₂₀)hydrocarbyl,
at each occurrence, L¹ is independently selected from the group consisting of a bond and a substituted or unsubstituted (C₁-C₂₀)hydrocarbylene interrupted or terminated by 0, 1, 2, or 3 groups chosen from —O—, —NH—, and —S—,
at least two of R⁵, R⁶, R⁷, and R⁸ comprise a carboxylic acid, a salt thereof, or an ester thereof, and
at each occurrence, R¹ is independently selected from the group consisting of —H, a counterion, and a substituted or unsubstituted (C₁-C₂₀)hydrocarbyl.

Embodiment 13 provides the method of Embodiment 12, wherein each of R², R³, R⁴, R⁵, R⁶, R⁷, and R⁸ is independently selected from the group consisting of —H and (C₁-C₁₀)alkyl, wherein at least two of R⁵, R⁶, R⁷, and R⁸ are substituted with at least one carboxylic acid.

Embodiment 14 provides the method of any one of Embodiments 12-13, wherein each of R², R³, R⁴, R⁵, and R⁸ is —H, and, at each occurrence, R⁶ and R⁷ are each independently selected from a carboxylic acid and (C₁-C₁₀)alkyl substituted by at least one carboxylic acid and interrupted or terminated by 0, 1, 2, or 3 groups chosen from —O—, —NH—, and —S—.

Embodiment 15 provides the method of any one of Embodiments 12-14, wherein, at each occurrence, L¹ is independently selected from the group consisting of a bond and a (C₁-C₁₀)alkylene interrupted or terminated by 0, 1, 2, or 3 groups chosen from —O—, —NH—, and —S—.

Embodiment 16 provides the method of any one of Embodiments 12-15, wherein, at each occurrence, L¹ is independently selected from the group consisting of a bond and a (C₁-C₅)alkylene.

Embodiment 17 provides the method of any one of Embodiments 12-16, wherein L¹ is methylene.

Embodiment 18 provides the method of any one of Embodiments 12-17, wherein at each occurrence, R¹ is selected from the group consisting of —H, (C₁-C₅)alkyl, Na⁺, K⁺, Li⁺, H⁺, Zn⁺, NH₄⁺, Ca²⁺, Mg²⁺, Zn²⁺, and Al³⁺.

Embodiment 19 provides the method of any one of Embodiments 12-18, wherein R¹ is —H.

Embodiment 20 provides the method of any one of Embodiments 12-19, wherein the scale inhibitor comprises repeating units having the structure:

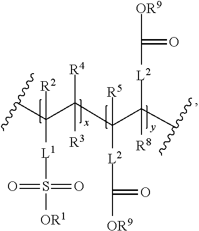

wherein
the repeating units are in block or random copolymer arrangement and, at each occurrence, independently occur in the direction shown or in the opposite direction,
at each occurrence, L² is independently selected from the group consisting of a bond and a substituted or unsubstituted (C₁-C₂₀)hydrocarbylene interrupted or terminated by 0, 1, 2, or 3 groups chosen from —O—, —NH—, and —S—, and
at each occurrence, R⁹ is independently selected from the group consisting of —H, a counterion, and a substituted or unsubstituted (C₁-C₂₀)hydrocarbyl.

Embodiment 21 provides the method of any one of Embodiments 12-20, wherein, at each occurrence, L² is independently selected from the group consisting of a bond and a (C₁-C₁₀)alkylene interrupted or terminated by 0, 1, 2, or 3 groups chosen from —O—, —NH—, and —S—.

Embodiment 22 provides the method of any one of Embodiments 12-21, wherein, at each occurrence, L² is independently selected from the group consisting of a bond and a (C₁-C₅)alkylene.

Embodiment 23 provides the method of any one of Embodiments 12-22, wherein L² is a bond.

Embodiment 24 provides the method of any one of Embodiments 12-23, wherein R⁹ is selected from the group consisting of —H, (C₁-C₅)alkyl, Na⁺, K⁺, Li⁺, H⁺, Zn⁺, NH₄⁺, Ca²⁺, Mg²⁺, Zn²⁺, and Al³⁺.

Embodiment 25 provides the method of any one of Embodiments 12-24, wherein R⁹ is —H.

Embodiment 26 provides the method of any one of Embodiments 12-25, wherein x is about 1 to about 200.

Embodiment 27 provides the method of any one of Embodiments 12-26, wherein x is about 4 to about 30.

Embodiment 28 provides the method of any one of Embodiments 12-27, wherein y is about 1 to about 200.

Embodiment 29 provides the method of any one of Embodiments 12-28, wherein y is about 4 to about 30.

Embodiment 30 provides the method of any one of Embodiments 12-29, wherein x/(x+y) is about 0.1% to about 99.9%.

Embodiment 31 provides the method of any one of Embodiments 12-30, wherein x/(x+y) is about 50% to about 90%.

Embodiment 32 provides the method of any one of Embodiments 12-31, wherein y/(x+y) is about 0.1% to about 99.9%.

Embodiment 33 provides the method of any one of Embodiments 12-32, wherein y/(x+y) is about 10% to about 50%.

Embodiment 34 provides the method of any one of Embodiments 12-33, wherein the repeating unit having degree of polymerization x and the repeating unit having degree of polymerization y are only two repeating units in the copolymer.

Embodiment 35 provides the method of any one of Embodiments 12-34, wherein the molecular weight of the scale inhibitor is about 500 g/mol to about 20,000 g/mol.

Embodiment 36 provides the method of any one of Embodiments 12-35, wherein the molecular weight of the scale inhibitor is about 2,500 g/mol to about 3,500 g/mol.

Embodiment 37 provides the method of any one of Embodiments 1-36, wherein the scale inhibitor comprises repeating units having the structure:

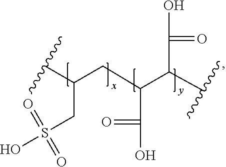

wherein the repeating units are in block or random copolymer arrangement and, at each occurrence, independently occur in the direction shown or in the opposite direction.

Embodiment 38 provides the method of any one of Embodiments 1-37, wherein the hydrolyzably-unmaskable coordinating groups comprise at least one of an ester, an anhydride, and an amide.

Embodiment 39 provides the method of any one of Embodiments 1-38, further comprising hydrolyzing at least some of the hydrolyzably-unmaskable coordinating groups while the composition is in the subterranean formation.

Embodiment 40 provides the method of any one of Embodiments 1-39, wherein the protected scale inhibitor comprising hydrolyzably-unmaskable coordinating groups is a polymer, wherein at least one repeating unit of the polymer comprises the hydrolyzably-unmaskable coordinating group.

Embodiment 41 provides the method of Embodiment 40, wherein the polymeric protected scale inhibitor comprising hydrolyzably-unmaskable coordinating groups comprises a repeating unit that is derived from a (C₁-C₂₀)hydrocarbyl ester, anhydride, or substituted or unsubstituted amide of at least one of a substituted or unsubstituted (C₃-C₂₀)alkenoic acid and a substituted or unsubstituted (C₁-C₂₀)hydrocarbylsulfonic acid.

Embodiment 42 provides the method of any one of Embodiments 40-41, wherein the polymeric protected scale inhibitor comprising hydrolyzably-unmaskable coordinating groups comprises a (C₁-C₂₀)hydrocarbyl ester, anhydride, or substituted or unsubstituted amide of at least one of a carboxylic acid- or sulfonic acid-substituted (C₂-C₂₀)hydrocarbylene, wherein the (C₂-C₂₀)hydrocarbylene is substituted or unsubstituted, an acrylamido-methyl propane sulfonate/acrylic acid copolymer (AMPS/AA), phosphinated maleic copolymer (PHOS/MA), a polymaleic acid/acrylic acid/acrylamido-methyl propane sulfonate terpolymer (PMA/AMPS), a phosphonate polymer, a polycarboxylate, a phosphorous-containing polycarboxylate, a phosphonic acid derivative, a phosphino-polylacrylate, and a copolymer comprising any one of the preceding polymers or copolymers.

Embodiment 43 provides the method of any one of Embodiments 40-42, wherein the repeating unit comprising the hydrolyzably-unmaskable coordinating group is hydrolyzable to form a repeating unit that is a carboxylic acid- or sulfonic acid-substituted (C₂-C₂₀)hydrocarbylene, wherein the (C₂-C₂₀)hydrocarbylene is substituted or unsubstituted.

Embodiment 44 provides the method of any one of Embodiments 40-43, wherein the polymeric protected scale inhibitor comprising hydrolyzably-unmaskable coordinating groups comprises at least one repeating unit that is derived from an acrylic acid or methacrylic acid isobutyl ester.

Embodiment 45 provides the method of any one of Embodiments 40-44, wherein the polymeric protected scale inhibitor comprising hydrolyzably-unmaskable coordinating groups comprises at least one repeating unit that is derived from an acrylic acid or methacrylic acid (C₁-C₅)ester, anhydride, or amide.

Embodiment 46 provides the method of any one of Embodiments 40-45, wherein the repeating unit comprising the hydrolyzably-unmaskable coordinating group is hydrolyzable to form a repeating unit that is —CH₂—CH(COOH)—.

Embodiment 47 provides the method of any one of Embodiments 40-46, wherein the polymeric protected scale inhibitor comprising hydrolyzably-unmaskable coordinating groups is a polyphosphonic acid (C₁-C₂₀)hydrocarbyl ester, anhydride, or substituted or unsubstituted amide.

Embodiment 48 provides the method of any one of Embodiments 1-47, wherein the protected scale inhibitor comprising hydrolyzably-unmaskable coordinating groups comprises a (C₁-C₂₀)hydrocarbyl ester, anhydride, or substituted or unsubstituted amide of at least one of a phosphate, a phosphate ester, phosphoric acid, a phosphonate, a phosphonic acid, a sulfonate, a phosphonic acid derivative, a phosphino-polylacrylate, a phosphonic acid ethylene diamine derivative, a phosphonic acid[1,2-ethanediylbis[nitrilobis(methylene)]]tetrakis (EDTMPA), amino tris(methylenephosphonic acid) (ATMP), 1-hydroxyethane 1,1-diphosphonic acid (HEDP), triethylamine phosphate ester, diethylene triamine penta(methylene phosphonic acid), and bis(hexamethylene)triamine penta(methylenephosphonic acid).

Embodiment 49 provides the method of any one of Embodiments 1-48, wherein the protected scale inhibitor comprising hydrolyzably-unmaskable coordinating groups is a substituted or unsubstituted (C₁-C₂₀)orthoalkanoic acid (C₁-C₂₀)hydrocarbyl ester, anhydride, or substituted or unsubstituted amide.

Embodiment 50 provides the method of any one of Embodiments 1-49, wherein the protected scale inhibitor comprising hydrolyzably-unmaskable coordinating groups is a substituted or unsubstituted (C₁-C₂₀)orthoalkanoic acid trimethyl ester.

Embodiment 51 provides the method of any one of Embodiments 1-50, wherein the aqueous phase and the lipophilic phase are an emulsion.

Embodiment 52 provides the method of any one of Embodiments 1-51, wherein the aqueous phase is about 0.01 vol % to about 99.99 vol % of the aqueous phase and the liphophilic phase.

Embodiment 53 provides the method of any one of Embodiments 1-52, wherein the aqueous phase is about 20 vol % to about 80 vol % of the aqueous phase and the liphophilic phase.

Embodiment 54 provides the method of any one of Embodiments 1-53, wherein the method further comprises exposing the composition to conditions in the subterranean formation such that at least some of the scale inhibitor enters the aqueous phase.

Embodiment 55 provides the method of Embodiment 54, wherein the conditions sufficient to move at least some of the scale inhibitor into the aqueous phase comprise at least one of temperature, pressure, and concentration of at least one of a salt, an oxidizing agent, a reducing agent, a mineral, a surfactant.

Embodiment 56 provides the method of any one of Embodiments 54-55, wherein the scale inhibitor comprises at least one of a carboxylic acid- or sulfonic acid-substituted (C₂-C₂₀)hydrocarbylene, wherein the (C₂-C₂₀)hydrocarbylene is substituted or unsubstituted, a phosphate, a phosphate ester, phosphoric acid, a phosphonate, a phosphonic acid, a polyacrylamide, an acrylamido-methyl propane sulfonate/acrylic acid copolymer (AMPS/AA), phosphinated maleic copolymer (PHOS/MA), a polymaleic acid/acrylic acid/acrylamido-methyl propane sulfonate terpolymer (PMA/AMPS), a sulfonate, a phosphonate polymer, a polyacrylic acid or an ester or amide thereof, a polymethacrylic acid or an ester or amide thereof, a polymaleic acid or an ester or amide thereof, a poly(sulfonic acid-substituted (C₂-C₂₀)alkene)) or an ester or amide thereof, a polycarboxylate, a phosphorous-containing polycarboxylate, a phosphonic acid derivative, a phosphino-polylacrylate, a phosphonic acid ethylene diamine derivative, a phosphonic acid[1,2-ethanediylbis[nitrilobis(methylene)]]tetrakis (EDTMPA), amino tris(methylenephosphonic acid) (ATMP), 1-hydroxyethane 1,1-diphosphonic acid (HEDP), triethylamine phosphate ester, diethylene triamine penta(methylene phosphonic acid), bis(hexamethylene)triamine penta(methylenephosphonic acid), a copolymer comprising any one of the preceding polymers or copolymers, and a salt of any one of the preceding acids or amides.

Embodiment 57 provides the method of any one of Embodiments 54-56, wherein the scale inhibitor comprises a polymer comprising at least one repeating unit that is a substituted or unsubstituted ethylene unit comprising at least one substituent that is selected from the group consisting of a carboxylic acid, a (C₁₋₂₀)hydrocarbyl ester thereof, and a substituted or unsubstituted amide thereof.

Embodiment 58 provides the method of any one of Embodiments 54-57, wherein the scale inhibitor comprises a polymer comprising repeating units derived from at least one monomer selected from the group consisting of acrylic acid, acrylic acid (C₁₋₁₀)alkyl ester, methacrylic acid, methacrylic acid (C₁₋₁₀)alkyl ester, acrylamide, and methacrylamide.

Embodiment 59 provides the method of any one of Embodiments 1-58, wherein the scale inhibitor is formed using emulsion polymerization.

Embodiment 60 provides the method of any one of Embodiments 1-59, wherein the composition further comprises a viscosifier.

Embodiment 61 provides the method of Embodiment 60, wherein the viscosifier is crosslinked or uncrosslinked.

Embodiment 62 provides the method of any one of Embodiments 60-61, wherein the viscosifier comprises at least one of a linear polysaccharide, and a polymer of a (C₂-C₅₀)hydrocarbyl having at least one carbon-carbon unsaturated aliphatic bond therein, wherein the (C₂-C₅₀)hydrocarbyl is substituted or unsubstituted.

Embodiment 63 provides the method of any one of Embodiments 1-62, wherein the composition further comprises a crosslinker.

Embodiment 64 provides the method of Embodiment 63, wherein the crosslinker comprises at least one of chromium, aluminum, antimony, zirconium, titanium, calcium, boron, iron, silicon, copper, zinc, magnesium, and an ion thereof.

Embodiment 65 provides the method of any one of Embodiments 63-64, wherein the crosslinker comprises at least one of boric acid, borax, a borate, a (C₁-C₃₀)hydrocarbylboronic acid, a (C₁-C₃₀)hydrocarbyl ester of a (C₁-C₃₀)hydrocarbylboronic acid, a (C₁-C₃₀)hydrocarbylboronic acid-modified polyacrylamide, ferric chloride, disodium octaborate tetrahydrate, sodium metaborate, sodium diborate, sodium tetraborate, disodium tetraborate, a pentaborate, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, zirconium lactate glycolate, titanium lactate, titanium malate, titanium citrate, titanium ammonium lactate, titanium triethanolamine, titanium acetylacetonate, aluminum lactate, and aluminum citrate.

Embodiment 66 provides the method of any one of Embodiments 63-65, wherein the crosslinker comprises at least one of a (C₁-C₂₀)alkylenebiacrylamide (e.g., methylenebisacrylamide), a poly((C₁-C₂₀)alkenyl)-substituted mono- or poly-(C₁-C₂₀)alkyl ether (e.g., pentaerythritol allyl ether), and a poly(C₂-C₂₀)alkenylbenzene (e.g., divinylbenzene). In some embodiments, the crosslinker can be at least one of alkyl diacrylate, ethylene glycol diacrylate, ethylene glycol dimethacrylate, polyethylene glycol diacrylate, polyethylene glycol dimethacrylate, ethoxylated bisphenol A diacrylate, ethoxylated bisphenol A dimethacrylate, ethoxylated trimethylol propane triacrylate, ethoxylated trimethylol propane trimethacrylate, ethoxylated glyceryl triacrylate, ethoxylated glyceryl trimethacrylate, ethoxylated pentaerythritol tetraacrylate, ethoxylated pentaerythritol tetramethacrylate, ethoxylated dipentaerythritol hexaacrylate, polyglyceryl monoethylene oxide polyacrylate, polyglyceryl polyethylene glycol polyacrylate, dipentaerythritol hexaacrylate, dipentaerythritol hexamethacrylate, neopentyl glycol diacrylate, neopentyl glycol dimethacrylate, pentaerythritol triacrylate, pentaerythritol trimethacrylate, trimethylol propane triacrylate, trimethylol propane trimethacrylate, tricyclodecane dimethanol diacrylate, tricyclodecane dimethanol dimethacrylate, 1,6-hexanediol diacrylate, and 1,6-hexanediol dimethacrylate.

Embodiment 67 provides the method of any one of Embodiments 1-66, wherein the composition further includes a breaker.

Embodiment 68 provides the method of Embodiment 67, wherein the breaker is at least one of an oxidative breaker and an enzymatic breaker.

Embodiment 69 provides the method of any one of Embodiments 67-68, wherein the breaker is at least one of a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a persulfate, percarbonate, perborate, peroxide, perphosphosphate, permanganate, chlorite, or hyperchlorite ion.

Embodiment 70 provides the method of any one of Embodiments 67-69, wherein the breaker is at least one of an alpha or beta amylase, amyloglucosidase, oligoglucosidase, invertase, maltase, cellulase, hemi-cellulase, and mannanohydrolase.

Embodiment 71 provides the method of any one of Embodiments 1-70, further comprising combining the composition with an aqueous or oil-based fluid comprising a drilling fluid, stimulation fluid, fracturing fluid, spotting fluid, clean-up fluid, completion fluid, remedial treatment fluid, abandonment fluid, pill, acidizing fluid, cementing fluid, packer fluid, or a combination thereof, to form a mixture, wherein the placing the composition in the subterranean formation comprises placing the mixture in the subterranean formation.

Embodiment 72 provides the method of Embodiment 71, wherein the cementing fluid comprises Portland cement, pozzolana cement, gypsum cement, high alumina content cement, slag cement, silica cement, or a combination thereof.

Embodiment 73 provides the method of any one of Embodiments 1-72, wherein at least one of prior to, during, and after the placing of the composition in the subterranean formation, the composition is used in the subterranean formation, at least one of alone and in combination with other materials, as a drilling fluid, stimulation fluid, fracturing fluid, spotting fluid, clean-up fluid, completion fluid, remedial treatment fluid, abandonment fluid, pill, acidizing fluid, cementing fluid, packer fluid, or a combination thereof.

Embodiment 74 provides the method of any one of Embodiments 1-73, wherein the composition further comprises water, saline, aqueous base, oil, organic solvent, synthetic fluid oil phase, aqueous solution, alcohol or polyol, cellulose, starch, alkalinity control agent, acidity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, rheology modifier, oil-wetting agent, set retarding additive, surfactant, corrosion inhibitor, gas, weight reducing additive, heavy-weight additive, lost circulation material, filtration control additive, salt, fiber, thixotropic additive, breaker, crosslinker, gas, rheology modifier, curing accelerator, curing retarder, pH modifier, chelating agent, scale inhibitor, enzyme, resin, water control material, polymer, oxidizer, a marker, Portland cement, pozzolana cement, gypsum cement, high alumina content cement, slag cement, silica cement, fly ash, metakaolin, shale, zeolite, a crystalline silica compound, amorphous silica, fibers, a hydratable clay, microspheres, pozzolan lime, or a combination thereof.

Embodiment 75 provides the method of any one of Embodiments 1-74, wherein the placing of the composition in the subterranean formation comprises fracturing at least part of the subterranean formation to form at least one subterranean fracture.

Embodiment 76 provides the method of any one of Embodiments 1-75, wherein the composition further comprises a proppant, a resin-coated proppant, or a combination thereof.

Embodiment 77 provides the method of any one of Embodiments 1-76, wherein the placing of the composition in the subterranean formation comprises pumping the composition through a drill string disposed in a wellbore, through a drill bit at a downhole end of the drill string, and back above-surface through an annulus.

Embodiment 78 provides the method of Embodiment 77, further comprising processing the composition exiting the annulus with at least one fluid processing unit to generate a cleaned composition and recirculating the cleaned composition through the wellbore.

Embodiment 79 provides a system for performing the method of any one of Embodiments 1-78, the system comprising:

a tubular disposed in the subterranean formation; and

a pump configured to pump the composition in the subterranean formation through the tubular.

Embodiment 80 provides a system for performing the method of any one of Embodiments 1-78, the system comprising:

a drillstring disposed in a wellbore, the drillstring comprising a drill bit at a downhole end of the drillstring;

an annulus between the drillstring and the wellbore; and

a pump configured to circulate the composition through the drill string, through the drill bit, and back above-surface through the annulus.

Embodiment 81 provides a method of treating a subterranean formation, the method comprising:

obtaining or providing a composition comprising
a scale inhibitor that is a copolymer comprising repeating units having the structure:

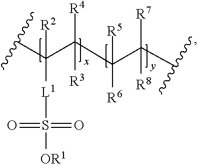

wherein
the repeating units are in block or random copolymer arrangement and, at each occurrence, independently occur in the direction shown or in the opposite direction,
at each occurrence, each of R², R³, R⁴, R⁵, R⁶, R⁷, and R⁸ is independently selected from the group consisting of —H and substituted or unsubstituted (C₁-C₂₀)hydrocarbyl,
at each occurrence, L¹ is independently selected from the group consisting of a bond and a substituted or unsubstituted (C₁-C₂₀)hydrocarbylene interrupted or terminated by 0, 1, 2, or 3 groups chosen from —O—, —NH—, and —S—,
at least two of R⁵, R⁶, R⁷, and R⁸ comprise a carboxylic acid, a salt thereof, or an ester thereof, and
at each occurrence, R¹ is independently selected from the group consisting of —H, a counterion, and a substituted or unsubstituted (C₁-C₂₀)hydrocarbyl; and

placing the composition in a subterranean formation.

Embodiment 82 provides the method of Embodiment 81, wherein the scale inhibitor comprises repeating units having the structure:

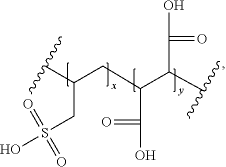

wherein the repeating units are in block or random copolymer arrangement and, at each occurrence, independently occur in the direction shown or in the opposite direction.

Embodiment 83 provides a system comprising:

a composition comprising a scale inhibitor, wherein at least one of A and B:
A) the scale inhibitor comprises at least one of
   a copolymer comprising a repeating unit comprising at least one sulfonic acid or sulfonate group and a repeating unit comprising at least two carboxylic acid or carboxylate groups; and
   a protected scale inhibitor comprising hydrolyzably-unmaskable coordinating groups;
B) the composition comprises an aqueous phase and a lipophilic phase, wherein the lipophilic phase protectively encapsulates the scale inhibitor; and

a subterranean formation comprising the composition therein.

Embodiment 84 provides the system of Embodiment 83, further comprising

a drillstring disposed in a wellbore, the drillstring comprising a drill bit at a downhole end of the drillstring;

an annulus between the drillstring and the wellbore; and

a pump configured to circulate the composition through the drill string, through the drill bit, and back above-surface through the annulus.

Embodiment 85 provides the system of any one of Embodiments 83-84, further comprising a fluid processing unit configured to process the composition exiting the annulus to generate a cleaned drilling fluid for recirculation through the wellbore.

Embodiment 86 provides the system of any one of Embodiments 83-85, further comprising

a tubular disposed in the subterranean formation;

a pump configured to pump the composition in the subterranean formation through the tubular.

Embodiment 87 provides a composition for treatment of a subterranean formation, the composition comprising:

a scale inhibitor, wherein at least one of A and B:
A) the scale inhibitor comprises at least one of
   a copolymer comprising a repeating unit comprising at least one sulfonic acid or sulfonate group and a repeating unit comprising at least two carboxylic acid or carboxylate groups; and
   a protected scale inhibitor comprising hydrolyzably-unmaskable coordinating groups;
   B) the composition comprises an aqueous phase and a lipophilic phase, wherein the lipophilic phase protectively encapsulates the scale inhibitor.

Embodiment 88 provides the composition of Embodiment 87, wherein the composition further comprises a downhole fluid.

Embodiment 89 provides the composition of any one of Embodiments 87-88, wherein the composition is a composition for fracturing of a subterranean formation.

Embodiment 90 provides a composition for treatment of a subterranean formation, the composition comprising:

a scale inhibitor that is a copolymer comprising repeating units having the structure:

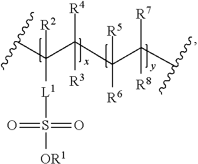

wherein
the repeating units are in block or random copolymer arrangement and, at each occurrence, independently occur in the direction shown or in the opposite direction,
at each occurrence, each of R², R³, R⁴, R⁵, R⁶, R⁷, and R⁸ is independently selected from the group consisting of —H and substituted or unsubstituted (C₁-C₂₀)hydrocarbyl,
at each occurrence, L¹ is independently selected from the group consisting of a bond and a substituted or unsubstituted (C₁-C₂₀)hydrocarbylene interrupted or terminated by 0, 1, 2, or 3 groups chosen from —O—, —NH—, and —S—,
at least two of R⁵, R⁶, R⁷, and R⁸ comprise a carboxylic acid, a salt thereof, or an ester thereof, and
at each occurrence, R¹ is independently selected from the group consisting of —H, a counterion, and a substituted or unsubstituted (C₁-C₂₀)hydrocarbyl.

Embodiment 91 provides the composition of Embodiment 90, wherein the scale inhibitor comprises repeating units having the structure:

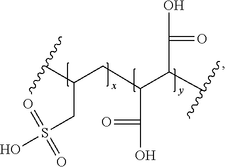

wherein the repeating units are in block or random copolymer arrangement and, at each occurrence, independently occur in the direction shown or in the opposite direction.

Embodiment 92 provides a method of preparing a composition for treatment of a subterranean formation, the method comprising:

forming a composition comprising a scale inhibitor, wherein at least one of A and B:
A) the scale inhibitor comprises at least one of
   a copolymer comprising a repeating unit comprising at least one sulfonic acid or sulfonate group and a repeating unit comprising at least two carboxylic acid or carboxylate groups; and
   a protected scale inhibitor comprising hydrolyzably-unmaskable coordinating groups;
B) the composition comprises an aqueous phase and a lipophilic phase, wherein the lipophilic phase protectively encapsulates the scale inhibitor.

Embodiment 93 provides the composition, method, or system of any one or any combination of Embodiments 1-92 optionally configured such that all elements or options recited are available to use or select from.

1-92. (canceled)

93. A method of treating a subterranean formation, the method comprising:
placing a composition comprising a scale inhibitor into the subterranean formation, wherein at least one of A and B:
A) the scale inhibitor comprises at least one of:
a copolymer comprising a repeating unit comprising at least one sulfonic acid or sulfonate group and a repeating unit comprising at least two carboxylic acid or carboxylate groups; and
a protected scale inhibitor comprising hydrolyzably-unmaskable coordinating groups; and
B) the composition comprises an aqueous phase and a lipophilic phase, wherein the lipophilic phase protectively encapsulates the scale inhibitor.

94. The method of claim 93, wherein about 0.01 wt % to about 5 wt % the composition is the scale inhibitor.

95. The method of claim 93, wherein the scale inhibitor comprises repeating units having the structure: 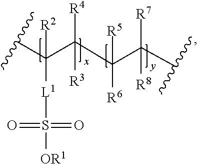
wherein:
the repeating units are in block or random copolymer arrangement, and at each occurrence, independently occur in the direction shown or in the opposite direction,
each of x and y is independently an integer of 1 to about 200,
at each occurrence, each of R², R³, R⁴, R⁵, R⁶, R⁷, and R⁸ is independently selected from the group consisting of —H and substituted or unsubstituted (C₁-C₂₀)hydrocarbyl,
at each occurrence, L¹ is independently selected from the group consisting of a bond and a substituted or unsubstituted (C₁-C₂₀)hydrocarbylene interrupted or terminated by 0, 1, 2, or 3 groups chosen from —O—, —NH—, and —S—,
at least two of R⁵, R⁶, R⁷, and R⁸ comprise a carboxylic acid, a salt thereof, or an ester thereof, and
at each occurrence, R¹ is independently selected from the group consisting of —H, a counterion, and a substituted or unsubstituted (C₁-C₂₀)hydrocarbyl.

96. The method of claim 95, wherein each of R², R³, R⁴, R⁵, and R⁸ is —H, and, at each occurrence, R⁶ and R⁷ are each independently selected from a carboxylic acid and (C₁-C₁₀)alkyl substituted by at least one carboxylic acid and interrupted or terminated by 0, 1, 2, or 3 groups chosen from —O—, —NH—, and —S—, wherein, at each occurrence, L¹ is independently selected from the group consisting of a bond and a (C₁-C₅)alkylene, and wherein, at each occurrence, L² is independently selected from the group consisting of a bond and a (C₁-C₅)alkylene.

97. The method of claim 95, wherein the scale inhibitor comprises repeating units having the structure: 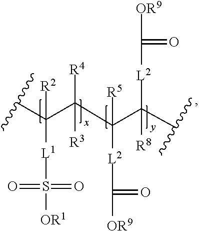
wherein:
the repeating units are in block or random copolymer arrangement, and at each occurrence, independently occur in the direction shown or in the opposite direction,
each of x and y is independently an integer of 1 to about 200,
at each occurrence, L² is independently selected from the group consisting of a bond and a substituted or unsubstituted (C₁-C₂₀)hydrocarbylene interrupted or terminated by 0, 1, 2, or 3 groups chosen from —O—, —NH—, and —S—, and
at each occurrence, R⁹ is independently selected from the group consisting of —H, a counterion, and a substituted or unsubstituted (C₁-C₂₀)hydrocarbyl.

98. The method of claim 95, wherein x is about 4 to about 30, and wherein y is about 4 to about 30.

99. The method of claim 93, wherein the scale inhibitor comprises repeating units having the structure: 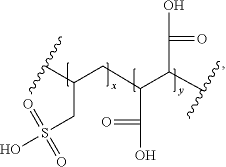
wherein:
the repeating units are in block or random copolymer arrangement, and at each occurrence, independently occur in the direction shown or in the opposite direction, and
each of x and y is independently an integer of 1 to about 200.

100. The method of claim 93, wherein the protected scale inhibitor comprising hydrolyzably-unmaskable coordinating groups is a polymer, wherein at least one repeating unit of the polymer comprises the hydrolyzably-unmaskable coordinating group.

101. The method of claim 100, wherein the polymeric protected scale inhibitor comprising hydrolyzably-unmaskable coordinating groups comprises a repeating unit that is derived from a (C₁-C₂₀)hydrocarbyl ester, anhydride, or substituted or unsubstituted amide of at least one of a substituted or unsubstituted (C₃-C₂₀)alkenoic acid and a substituted or unsubstituted (C₁-C₂₀)hydrocarbylsulfonic acid.

102. The method of claim 100, wherein the polymeric protected scale inhibitor comprising hydrolyzably-unmaskable coordinating groups comprises a (C₁-C₂₀)hydrocarbyl ester, anhydride, or substituted or unsubstituted amide of at least one of a carboxylic acid- or sulfonic acid-substituted (C₂-C₂₀)hydrocarbylene, wherein the (C₂-C₂₀)hydrocarbylene is substituted or unsubstituted, an acrylamido-methyl propane sulfonate/acrylic acid copolymer (AMPS/AA), phosphinated maleic copolymer (PHOS/MA), a polymaleic acid/acrylic acid/acrylamido-methyl propane sulfonate terpolymer (PMA/AMPS), a phosphonate polymer, a polycarboxylate, a phosphorous-containing polycarboxylate, a phosphonic acid derivative, a phosphino-polylacrylate, and a copolymer comprising any one of the preceding polymers or copolymers.

103. The method of claim 93, wherein the scale inhibitor comprises at least one of a carboxylic acid- or sulfonic acid-substituted (C₂-C₂₀)hydrocarbylene, wherein the (C₂-C₂₀)hydrocarbylene is substituted or unsubstituted, a phosphate, a phosphate ester, phosphoric acid, a phosphonate, a phosphonic acid, a polyacrylamide, an acrylamido-methyl propane sulfonate/acrylic acid copolymer (AMPS/AA), phosphinated maleic copolymer (PHOS/MA), a polymaleic acid/acrylic acid/acrylamido-methyl propane sulfonate terpolymer (PMA/AMPS), a sulfonate, a phosphonate polymer, a polyacrylic acid or an ester or amide thereof, a polymethacrylic acid or an ester or amide thereof, a polymaleic acid or an ester or amide thereof, a poly(sulfonic acid-substituted (C₂-C₂₀)alkene)) or an ester or amide thereof, a polycarboxylate, a phosphorous-containing polycarboxylate, a phosphonic acid derivative, a phosphino-polylacrylate, a phosphonic acid ethylene diamine derivative, a phosphonic acid[1,2-ethanediylbis[nitrilobis(methylene)]]tetrakis (EDTMPA), amino tris(methylenephosphonic acid) (ATMP), 1-hydroxyethane 1,1-diphosphonic acid (HEDP), triethylamine phosphate ester, diethylene triamine penta(methylene phosphonic acid), bis(hexamethylene)triamine penta(methylenephosphonic acid), a copolymer comprising any one of the preceding polymers or copolymers, and a salt of any one of the preceding acids or amides.

104. The method of claim 93, wherein the scale inhibitor comprises a polymer comprising at least one repeating unit that is a substituted or unsubstituted ethylene unit comprising at least one substituent that is selected from the group consisting of a carboxylic acid, a (C₁₋₂₀)hydrocarbyl ester thereof, and a substituted or unsubstituted amide thereof.

105. The method of claim 93, wherein the scale inhibitor comprises a polymer comprising repeating units derived from at least one monomer selected from the group consisting of acrylic acid, acrylic acid (C₁₋₁₀)alkyl ester, methacrylic acid, methacrylic acid (C₁₋₁₀)alkyl ester, acrylamide, and methacrylamide.

106. The method of claim 93, wherein the composition further comprises a crosslinker, and wherein the crosslinker comprises at least one of boric acid, borax, a borate, a (C₁-C₃₀)hydrocarbylboronic acid, a (C₁-C₃₀)hydrocarbyl ester of a (C₁-C₃₀)hydrocarbylboronic acid, a (C₁-C₃₀)hydrocarbylboronic acid-modified polyacrylamide, ferric chloride, disodium octaborate tetrahydrate, sodium metaborate, sodium diborate, sodium tetraborate, disodium tetraborate, a pentaborate, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, zirconium lactate glycolate, titanium lactate, titanium malate, titanium citrate, titanium ammonium lactate, titanium triethanolamine, titanium acetylacetonate, aluminum lactate, and aluminum citrate.

107. The method of claim 93, wherein the composition further comprises a crosslinker, and wherein the crosslinker comprises at least one of a (C₁-C₂₀)alkylenebiacrylamide (e.g., methylenebisacrylamide), a poly((C₁-C₂₀)alkenyl)-substituted mono- or poly-(C₁-C₂₀)alkyl ether (e.g., pentaerythritol allyl ether), and a poly(C₂-C₂₀)alkenylbenzene (e.g., divinylbenzene), alkyl diacrylate, ethylene glycol diacrylate, ethylene glycol dimethacrylate, polyethylene glycol diacrylate, polyethylene glycol dimethacrylate, ethoxylated bisphenol A diacrylate, ethoxylated bisphenol A dimethacrylate, ethoxylated trimethylol propane triacrylate, ethoxylated trimethylol propane trimethacrylate, ethoxylated glyceryl triacrylate, ethoxylated glyceryl trimethacrylate, ethoxylated pentaerythritol tetraacrylate, ethoxylated pentaerythritol tetramethacrylate, ethoxylated dipentaerythritol hexaacrylate, polyglyceryl monoethylene oxide polyacrylate, polyglyceryl polyethylene glycol polyacrylate, dipentaerythritol hexaacrylate, dipentaerythritol hexamethacrylate, neopentyl glycol diacrylate, neopentyl glycol dimethacrylate, pentaerythritol triacrylate, pentaerythritol trimethacrylate, trimethylol propane triacrylate, trimethylol propane trimethacrylate, tricyclodecane dimethanol diacrylate, tricyclodecane dimethanol dimethacrylate, 1,6-hexanediol diacrylate, and 1,6-hexanediol dimethacrylate.

108. The method of claim 93, wherein the placing of the composition in the subterranean formation comprises fracturing at least part of the subterranean formation to form at least one subterranean fracture.

109. The method of claim 93, wherein the placing of the composition in the subterranean formation comprises pumping the composition through a drill string disposed in a wellbore, through a drill bit at a downhole end of the drill string, and back above-surface through an annulus, and further comprising processing the composition exiting the annulus with at least one fluid processing unit to generate a cleaned composition and recirculating the cleaned composition through the wellbore.

110. A system for performing the method of claim 93, the system comprising:
a drill string disposed in a wellbore, the drill string comprising a drill bit at a downhole end of the drill string;
an annulus between the drill string and the wellbore; and
a pump configured to circulate the composition through the drill string, through the drill bit, and back above-surface through the annulus.

111. A method of treating a subterranean formation, the method comprising:
placing a composition comprising a scale inhibitor into the subterranean formation, the scale inhibitor is a copolymer comprising repeating units having the structure: 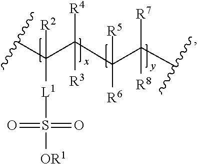
wherein:
the repeating units are in block or random copolymer arrangement, and at each occurrence, independently occur in the direction shown or in the opposite direction,
each of x and y is independently an integer of 1 to about 200, at each occurrence, each of R², R³, R⁴, R⁵, R⁶, R⁷, and R⁸ is independently selected from the group consisting of —H and substituted or unsubstituted (C₁-C₂₀)hydrocarbyl,
at each occurrence, L¹ is independently selected from the group consisting of a bond and a substituted or unsubstituted (C₁-C₂₀)hydrocarbylene interrupted or terminated by 0, 1, 2, or 3 groups chosen from —O—, —NH—, and —S—,
at least two of R⁵, R⁶, R⁷, and R⁸ comprise a carboxylic acid, a salt thereof, or an ester thereof, and
at each occurrence, R¹ is independently selected from the group consisting of —H, a counterion, and a substituted or unsubstituted (C₁-C₂₀)hydrocarbyl.

112. A composition for treatment of a subterranean formation, the composition comprising:
a scale inhibitor that is a copolymer comprising repeating units having the structure: 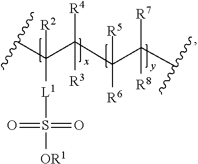
wherein:
the repeating units are in block or random copolymer arrangement, and at each occurrence, independently occur in the direction shown or in the opposite direction,
each of x and y is independently an integer of 1 to about 200, at each occurrence, each of R², R³, R⁴, R⁵, R⁶, R⁷, and R⁸ is independently selected from the group consisting of —H and substituted or unsubstituted (C₁-C₂₀)hydrocarbyl,
at each occurrence, L¹ is independently selected from the group consisting of a bond and a substituted or unsubstituted (C₁-C₂₀)hydrocarbylene interrupted or terminated by 0, 1, 2, or 3 groups chosen from —O—, —NH—, and —S—,
at least two of R⁵, R⁶, R⁷, and R⁸ comprise a carboxylic acid, a salt thereof, or an ester thereof, and
at each occurrence, R¹ is independently selected from the group consisting of —H, a counterion, and a substituted or unsubstituted (C₁-C₂₀)hydrocarbyl.
